(19) United States
(12) Patent Application Publication
(10) Pub. No.: US 2019/0012109 A1
(43) Pub. Date: Jan. 10, 2019

(54) MEMORY SYSTEM AND OPERATING METHOD FOR THE MEMORY SYSTEM

(71) Applicant: SK hynix Inc., Gyeonggi-do (KR)

(72) Inventor: Eu-Joon BYUN, Gyeonggi-do (KR)

(21) Appl. No.: 15/888,575

(22) Filed: Feb. 5, 2018

(30) Foreign Application Priority Data
Jul. 6, 2017 (KR) 10-2017-0085764

(51) Int. Cl. G06F 3/06

(52) U.S. Cl. CPC G06F 3/0647; G06F 3/0608; G06F 3/0673; G06F 3/065; G06F 3/064

(57) ABSTRACT

A memory system including: a memory device including a plurality of memory blocks each of which includes a plurality of pages that store data; and a controller suitable for receiving a plurality of write commands from a host, performing program operations corresponding to the write commands to program data in a first direction in a first memory block group, and copying the programmed data from the first memory block group into a second memory block group in a second direction.

### CROSS-REFERENCE TO RELATED APPLICATIONS

The present application claims priority of Korean Patent Application No. 10-2017-0085764, filed on Jul. 6, 2017, which is incorporated herein by reference in its entirety.

### BACKGROUND

### 1. Field

Exemplary embodiments of the present invention relate to a memory system, and more particularly, to a memory system capable of processing data with a memory device, and a method for operating the memory system.

### 2. Description of the Related Art

The paradigm for computing environments is shifting toward ubiquitous computing which allows users to use computer systems anytime anywhere. For this reason, the demands for portable electronic devices, such as mobile phones, digital cameras and laptop computers are soaring. Those electronic devices generally include a memory system using a memory device such as a data storage device. The data storage device may be used as a main memory unit or an auxiliary memory unit of a portable electronic device.

Since the data storage device using a memory device is not provided with a mechanical driving unit, it may have excellent stability and durability. Also, the data storage device has a quick data access rate with low power consumption. Non-limiting examples of the data storage device having such advantages include Universal Serial Bus (USB) memory devices, memory cards of diverse interfaces, Solid-State Drives (SSD) and the like.

### SUMMARY

Embodiments of the present invention are directed to a memory system capable of processing data with a memory device quickly and stably by minimizing the complexity and performance deterioration of the memory system and maximizing the utility efficiency of the memory device, and a method for operating the memory system.

In accordance with an embodiment of the present invention, a memory device including a plurality of memory blocks each of which includes a plurality of pages that store data; and a controller suitable for receiving a plurality of write commands from a host, performing program operations corresponding to the write commands to program data in a first direction in a first memory block group, and copying the programmed data from the first memory block group into a second memory block group in a second direction.

The first direction is a forward direction according to block indices or block numbers of source memory blocks included in the first memory block group, and page indices or page numbers of pages included in each of the source memory blocks, and wherein the second direction is a reverse direction to the first direction.

The controller may detect map data for source memory blocks included in the first memory block group; detect valid pages included in the source memory blocks based on the map data; and copy data programmed in the valid pages into target memory blocks of the second memory block group in the second direction.

The controller may program data into the first memory block group in the first direction from a first source memory block of the first memory block group toward a second source memory block of the first memory block group; and program the data into each of the source memory blocks in the first direction from a first page toward a second page.

The controller may copy the programmed data in the second direction from the second source memory block toward the first source memory block into the second memory block group; and copy the programmed data in the second direction from the second page toward the first page of each of the source memory blocks into the second memory block group.

The controller may store the copied data into the second memory block group in the first direction from a first target memory block toward a second target memory block in the second memory block group; and store the copied data into each of target memory blocks in the first direction from a first page toward a second page.

The controller may detect map data for source memory blocks included in the first memory block group; copy data stored in all pages of a first source memory block whose map data are not normally detected into the second memory block group; and copy data stored in valid pages of a second source memory block whose map data are normally detected into the second memory block group.

The controller may detect valid data for the data copied from the second source memory block through an update of the map data for the second memory block group; and update only the valid data when the map data are updated.

The controller may copy the programmed data in the second direction from the second source memory block toward the first source memory block into the second memory block group; copy the programmed data in the first direction from a first page toward a second page in the second source memory block into the second memory block group; and copy the programmed data in the second direction from a second page toward a first page in the first source memory block into the second memory block group.

The controller may copy the programmed data in the second direction from the second source memory block toward the first source memory block into the second memory block group; and copy the programmed data in the second direction from a second page toward a first page in each of the source memory block into the second memory block group.

In accordance with another embodiment of the present invention, a method for operating a memory system includes: receiving a plurality of write commands from a host for a memory device including a plurality of memory blocks each of which includes a plurality of pages that store data; performing program operations corresponding to the write commands to program data in a first direction in a first memory block group; and copying the programmed data from the first memory block group into a second memory block group in a second direction.

The first direction is a forward direction according to block indices or block numbers of source memory blocks included in the first memory block group, and page indices or page numbers of pages included in each of the source memory blocks, and the second direction is a reverse direction to the first direction.

The copying of the data programmed in the first memory block group into the second memory block group in the second direction includes: detecting map data for source memory blocks included in the first memory block group; detecting valid pages included in the source memory blocks based on the map data; and copying the programmed data in the valid pages into target memory blocks of the second memory block group in the second direction.

The performing of the program operations corresponding to the write commands in the first direction in the first memory block group includes: programming data into the first memory block group in the first direction from a first source memory block of the first memory block group toward a second source memory block of the first memory block group; and programming the data into each of the source memory blocks in the first direction from a first page toward a second page.

The copying of the data programmed in the first memory block group into the second memory block group in the second direction includes: copying the programmed data in the second direction from the second source memory block toward the first source memory block into the second memory block group; and copying the programmed data in the second direction from the second page toward the first page of each of the source memory blocks into the second memory block group.

The copying of the data programmed in the first memory block group into the second memory block group in the second direction further includes: storing the copied data into the second memory block group in the first direction from a first target memory block toward a second target memory block in the second memory block group; and storing the copied data into each of target memory blocks in the first direction from a first page toward a second page.

The copying of the data programmed in the first memory block group into the second memory block group in the second direction further includes: detecting map data for source memory blocks included in the first memory block group; copying data stored in all pages of a first source memory block whose map data are not normally detected into the second memory block group; and copying data stored in valid pages of a second source memory block whose map data are normally detected into the second memory block group.

The method may further include: detecting valid data for the data copied from the second source memory block through an update of the map data for the second memory block group; and updating only the valid data when the map data are updated.

The copying of the data programmed in the first memory block group into the second memory block group in the second direction includes: copying the programmed data in the second direction from the second source memory block toward the first source memory block into the second memory block group; copying the programmed data in the first direction from a first page toward a second page in the second source memory block into the second memory block group; and copying the programmed data in the second direction from a second page toward a first page in the first source memory block into the second memory block group.

The copying of the data programmed in the first memory block group into the second memory block group in the second direction includes: copying the programmed data in the second direction from the second source memory block toward the first source memory block into the second memory block group; and copying the programmed data in the second direction from a second page toward a first page in each of the source memory block into the second memory block group.

In accordance with another embodiment of the present invention, a memory system may include: a memory device; and a controller adapted to control the memory device to perform a garbage collection operation to source memory blocks in reverse of a program order, and to target memory blocks in the program order.

### BRIEF DESCRIPTION OF THE DRAWINGS

FIG. 1 is a block diagram illustrating a data processing system including a memory system in accordance with an embodiment of the present invention.

FIG. 2 is a schematic diagram illustrating an exemplary configuration of a memory device employed in the memory system shown in FIG. 1.

FIG. 3 is a circuit diagram illustrating an exemplary configuration of a memory cell array of a memory block in the memory device shown in FIG. 2.

FIG. 4 is a schematic diagram illustrating an exemplary three-dimensional structure of the memory device shown in FIG. 2.

FIGS. 5 to 9 illustrate an example of a data processing operation when a plurality of command operations corresponding to a plurality of commands are performed in a memory system in accordance with an embodiment of the present invention.

FIG. 10 is a flowchart describing an operation of processing data in the memory system in accordance with the embodiment of the present invention.

FIGS. 11 to 19 are diagrams schematically illustrating application examples of the data processing system shown in FIG. 1, in accordance with various embodiments of the present invention.

### DETAILED DESCRIPTION

Various embodiments of the present invention are described below in more detail with reference to the accompanying drawings. However, the present invention may be embodied in different other embodiments, forms and variations thereof and should not be construed as being limited to the embodiments set forth herein. Rather, the described embodiments are provided so that this disclosure will be thorough and complete, and will fully convey the present invention to those skilled in the art to which this invention pertains. Throughout the disclosure, like reference numerals refer to like parts throughout the various figures and embodiments of the present invention.

It will be understood that, although the terms “first”, “second”, “third”, and so on may be used herein to describe various elements, these elements are not limited by these terms. These terms are used to distinguish one element from another element. Thus, a first element described below could also be termed as a second or third element without departing from the spirit and scope of the present invention.

The drawings are not necessarily to scale and, in some instances, proportions may have been exaggerated in order to clearly illustrate features of the embodiments. When an element is referred to as being connected or coupled to another element, it should be understood that the former can be directly connected or coupled to the latter, or electrically connected or coupled to the latter via an intervening element therebetween.

It will be further understood that when an element is referred to as being “connected to”, or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present.

The terminology used herein is for the purpose of describing particular embodiments only and is not intended to be limiting of the present invention.

As used herein, singular forms are intended to include the plural forms as well, unless the context clearly indicates otherwise.

It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

Unless otherwise defined, all terms including technical and scientific terms used herein have the same meaning as commonly understood by one of ordinary skill in the art to which the present invention belongs in view of the present disclosure. It will be further understood that terms, such as those defined in commonly used dictionaries, should be interpreted as having a meaning that is consistent with their meaning in the context of the present disclosure and the relevant art, and should not be interpreted in an idealized or overly formal sense unless expressly so defined herein.

In the following description, numerous specific details are set forth in order to provide a thorough understanding of the present invention. The present invention may be practiced without some or all of these specific details. In other instances, well-known process structures and/or processes have not been described in detail in order not to unnecessarily obscure the present invention.

It is also noted, that in some instances, as would be apparent to those skilled in the relevant art, a feature or element described in connection with one embodiment may be used singly or in combination with other features or elements of another embodiment, unless otherwise specifically indicated.

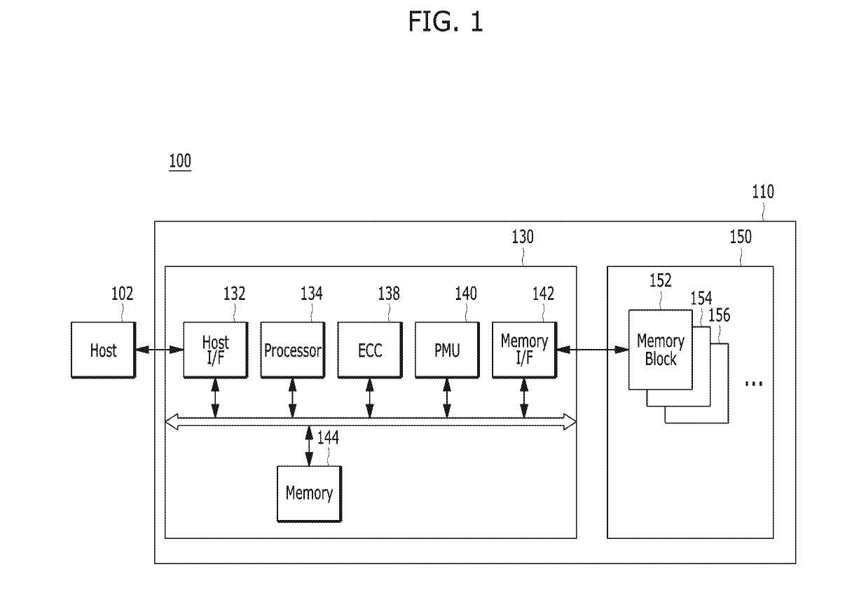

FIG. 1 is a block diagram illustrating a data processing system 100 in accordance with an embodiment of the present invention.

Referring to FIG. 1, the data processing system 100 may include a host 102 operatively coupled to a memory system 110.

The host 102 may include, for example, a portable electronic device such as a mobile phone, an MP3 player and a laptop computer or an electronic device such as a desktop computer, a game player, a TV, a projector and the like.

The memory system 110 may operate in response to a request from the host 102, and in particular, store data to be accessed by the host 102. The memory system 110 may be used as a main memory system or an auxiliary memory system of the host 102. The memory system 110 may be implemented with any one of various types of storage devices, which may be electrically coupled with the host 102, according to a protocol of a host interface. Examples of suitable storage devices include a solid state drive (SSD), a multimedia card (MMC), an embedded MMC (eMMC), a reduced size MMC (RS-MMC) and a micro-MMC, a secure digital (SD) card, a mini-SD and a micro-SD, a universal serial bus (USB) storage device, a universal flash storage (UFS) device, a compact flash (CF) card, a smart media (SM) card, a memory stick, and the like.

The storage devices for the memory system 110 may be implemented with a volatile memory device such as a dynamic random access memory (DRAM) and a static RAM (SRAM) and nonvolatile memory device such as a read only memory (ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), resistive RAM (RRAM) and a flash memory.

The memory system 110 may include a memory device 150 which stores data to be accessed by the host 102, and a controller 130 which may control storage of data in the memory device 150.

The controller 130 and the memory device 150 may be integrated into a single semiconductor device, which may be included in the various types of memory systems as exemplified above.

The memory system 110 may be configured as part of a computer, an ultra-mobile PC (UMPC), a workstation, a net-book, a personal digital assistant (PDA), a portable computer, a web tablet, a tablet computer, a wireless phone, a mobile phone, a smart phone, an e-book, a portable multimedia player (PMP), a portable game player, a navigation system, a black box, a digital camera, a digital multimedia broadcasting (DMB) player, a 3D television, a smart television, a digital audio recorder, a digital audio player, a digital picture recorder, a digital picture player, a digital video recorder, a digital video player, a storage configuring a data center, a device capable of transmitting and receiving information under a wireless environment, one of various electronic devices configuring a home network, one of various electronic devices configuring a computer network, one of various electronic devices configuring a telematics network, a radio frequency identification (RFID) device, or one of various component elements configuring a computing system.

The memory device 150 may be a nonvolatile memory device and may retain data stored therein even though power is not supplied. The memory device 150 may store data provided from the host 102 through a write operation, and provide data stored therein to the host 102 through a read operation. The memory device 150 may include a plurality of memory blocks 152 to 156, each of which may include a plurality of pages. Each of the pages may include a plurality of memory cells to which a plurality of word lines (WL) are electrically coupled.

The controller 130 may control overall operations of the memory device 150, such as read, write, program and erase operations. For example, the controller 130 of the memory system 110 may control the memory device 150 in response to a request from the host 102. The controller 130 may provide the data read from the memory device 150, to the host 102, and/or may store the data provided from the host 102 into the memory device 150.

The controller 130 may include a host interface (I/F) unit 132, a processor 134, an error correction code (ECC) unit 138, a power management unit (PMU) 140, a memory device controller such as a memory interface (I/F) unit 142 and a memory 144 all operatively coupled via an internal bus.

The host interface unit 132 may process commands and data provided from the host 102, and may communicate with the host 102 through at least one of various interface protocols such as universal serial bus (USB), multimedia card (MMC), peripheral component interconnect-express (PCI-E), small computer system interface (SCSI), serial-attached SCSI (SAS), serial advanced technology attachment (SATA), parallel advanced technology attachment (DATA), small computer system interface (SCSI), enhanced small disk interface (ESDI) and integrated drive electronics (IDE).

The ECC unit 138 may detect and correct errors in the data read from the memory device 150 during the read operation. The ECC unit 138 may not correct error bits when the number of the error bits is greater than or equal to a threshold number of correctable error bits, and may output an error correction fail signal indicating failure in correcting the error bits.

The ECC unit 138 may perform an error correction operation based on a coded modulation such as a low density parity check (LDDC) code, a Bose-Chaudhuri-Hocquenghem (BCH) code, a turbo code, a Reed-Solomon (RS) code, a convolution code, a recursive systematic code (RSC), a trellis-coded modulation (TCM), a Block coded modulation (BCM), and so on. The ECC unit 138 may include all circuits, modules, systems or devices for the error correction operation.

The PMU 140 may provide and manage power of the controller 130.

The memory interface 142 may serve as a memory/storage interface between the controller 130 and the memory device 150 to allow the controller 130 to control the memory device 150 in response to a request from the host 102. The memory interface 142 may generate a control signal for the memory device 150 and process data to be provided to the memory device 150 under the control of the processor 134 when the memory device 150 is a flash memory and, in particular, when the memory device 150 is a NAND flash memory.

The memory 144 may serve as a working memory of the memory system 110 and the controller 130, and store data for driving the memory system 110 and the controller 130. The controller 130 may control the memory device 150 in response to a request from the host 102. The controller 130 may provide data read from the memory device 150 to the host 102, may store data provided from the host 102 into the memory device 150. The memory 144 may store data required for the controller 130 and the memory device 150 to perform these operations.

The memory 144 may be implemented with a volatile memory. The memory 144 may be implemented with a static random access memory (SRAM) or a dynamic random access memory (DRAM). The memory 144 may be disposed within or out of the controller 130. FIG. 1 exemplifies the memory 144 disposed within the controller 130. In an embodiment, the memory 144 may be embodied by an external volatile memory having a memory interface transferring data between the memory 144 and the controller 130.

The processor 134 may control the overall operations of the memory system 110. The processor 134 may drive firmware to control the overall operations of the memory system 110. The firmware may be referred to as flash translation layer (FTL).

A FTL may perform an operation as an interface between the host 102 and the memory device 150. The host 102 may request to the memory device 150 write and read operations through the FTL.

The FTL may manage operations of address mapping, garbage collection, wear-leveling and so forth. Particularly, the FTL may store map data. Therefore, the controller 130 may map a logical address, which is provided from the host 102, to a physical address of the memory device 150 through the map data. The memory device 150 may perform an operation like a general device because of the address mapping operation. Also, through the address mapping operation based on the map data, when the controller 130 updates data of a particular page, the controller 130 may program new data into another empty page and may invalidate old data of the particular page due to a characteristic of a flash memory device. Further, the controller 130 may store map data of the new data into the FTL.

The processor 134 may be implemented with a microprocessor or a central processing unit (CPU). The memory system 110 may include one or more processors 134.

A management unit (not shown) may be included in the processor 134, and may perform bad block management of the memory device 150. The management unit may find bad memory blocks included in the memory device 150, which are in unsatisfactory condition for further use, and perform bad block management on the bad memory blocks. When the memory device 150 is a flash memory, for example, a NAND flash memory, a program failure may occur during the write operation, for example, during the program operation, due to characteristics of a NAND logic function. During the bad block management, the data of the program-failed memory block or the bad memory block may be programmed into a new memory block. Also, the bad blocks due to the program fail seriously deteriorates the utilization efficiency of the memory device 150 having a 3D stack structure and the reliability of the memory system 100, and thus reliable bad block management is required.

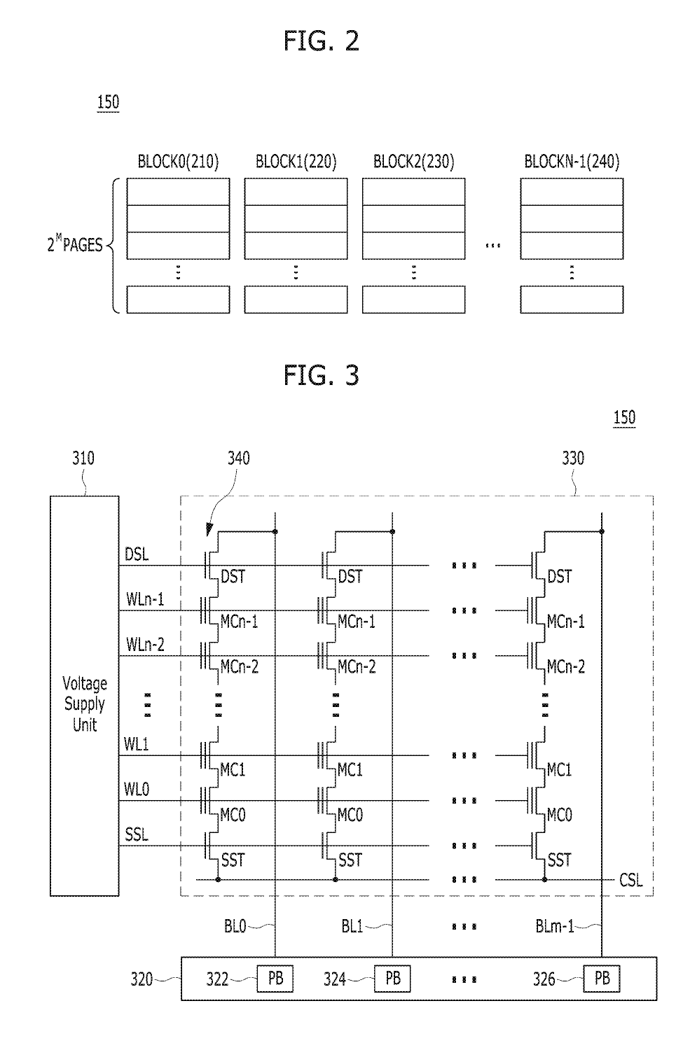

FIG. 2 is a schematic diagram illustrating the memory device 150.

Referring to FIG. 2, the memory device 150 may include the plurality of memory blocks BLOCK 0 to BLOCKN-1, and each of the blocks BLOCK 0 to BLOCKN-1 may include a plurality of pages, for example, 2^{M} pages, the number of which may vary according to circuit design. The memory device 150 may include a plurality of memory blocks, such as single level cell (SLC) memory blocks and multi-level cell (MLC) memory blocks, according to the number of bits which may be stored or expressed in each memory cell. The SLC memory block may include a plurality of pages which are implemented with memory cells each capable of storing 1-bit data. The MLC memory block may include a plurality of pages which are implemented with memory cells each capable of storing multi-bit data, for example, two or more-bit data. An MLC memory block including a plurality of pages which are implemented with memory cells that are each capable of storing 3-bit data may be defined as a triple level cell (TLC) memory block.

FIG. 3 is a circuit diagram illustrating a memory block 330 in the memory device 150.

Referring to FIG. 3, the memory block 330 corresponds to any of the plurality of memory blocks 152 to 156.

Referring to FIG. 3, the memory block 152 of the memory device 150 may include a plurality of cell strings 340 which are electrically coupled to bit lines BL0 to BLm-1, respectively. The cell string 340 of each column may include at least one drain select transistor DST and at least one source select transistor SST. A plurality of memory cells or a plurality of memory cell transistors MC0 to MCn-1 may be electrically coupled in series between the select transistors DST and SST. The respective memory cells MC0 to MCn-1 may be configured by single level cells (SLC) each of which may store 1 bit of information, or by multi-level cells (MLC) each of which may store data information of a plurality of bits. The strings 340 may be electrically coupled to the corresponding bit lines BL0 to BLm-1, respectively. For reference, in FIG. 3, ‘DSL’ denotes a drain select line, ‘SSL’ denotes a source select line, and ‘CSL’ denotes a common source line.

While FIG. 3 only shows, as an example, the memory block 152 which is configured by NAND flash memory cells, it is to be noted that the memory block 152 of the memory device 150 according to the embodiment is not limited to NAND flash memory and may be realized by NOR flash memory, hybrid flash memory in which at least two kinds of memory cells are combined, or one-NAND flash memory in which a controller is built in a memory chip. The operational characteristics of a semiconductor device may be applied to not only a flash memory device in which a charge storing layer is configured by conductive floating gates but also a charge trap flash (CTF) in which a charge storing layer is configured by a dielectric layer.

A voltage supplied unit 310 of the memory device 150 may provide word line voltages, for example, a program voltage, a read voltage and a pass voltage, to be supplied to respective word lines according to an operation mode and voltages to be supplied to bulks, for example, well regions in which the memory cells are formed. The voltage supplied unit 310 may perform a voltage generating operation under the control of a control circuit (not shown). The voltage supplied unit 310 may generate a plurality of variable read voltages to generate a plurality of read data, select one of the memory blocks or sectors of a memory cell array under the control of the control circuit, select one of the word lines of the selected memory block, and provide the word line voltages to the selected word line and unselected word lines.

A read/write circuit 320 of the memory device 150 may be controlled by the control circuit, and may serve as a sense amplifier or a write driver according to an operation mode. During a verification/normal read operation, the read/write circuit 320 may operate as a sense amplifier for reading data from the memory cell array. During a program operation, the read/write circuit 320 may operate as a write driver for driving bit lines according to data to be stored in the memory cell array. During a program operation, the read/write circuit 320 may receive from a buffer (not illustrated) data to be stored into the memory cell array, and drive bit lines according to the received data. The read/write circuit 320 may include a plurality of page buffers 322 to 326 respectively corresponding to columns (or bit lines) or column pairs (or bit line pairs), and each of the page buffers 322 to 326 may include a plurality of latches (not illustrated).

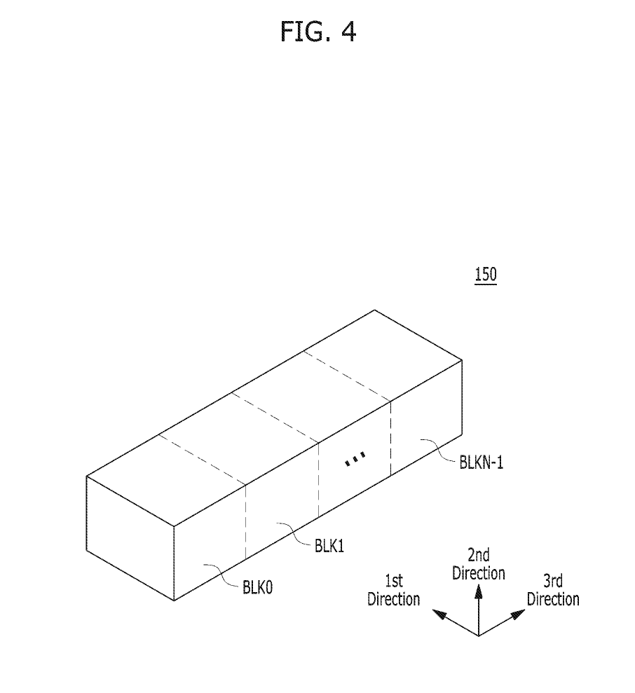

FIG. 4 is a schematic diagram illustrating a 3D structure of the memory device 150.

The memory device 150 may be embodied by a 2D or 3D memory device. Specifically, as illustrated in FIG. 4, the memory device 150 may be embodied by a nonvolatile memory device having a 3D stack structure. When the memory device 150 has a 3D structure, the memory device 150 may include a plurality of memory blocks BLK0 to BLKN-1 each having a 3D structure (or vertical structure).

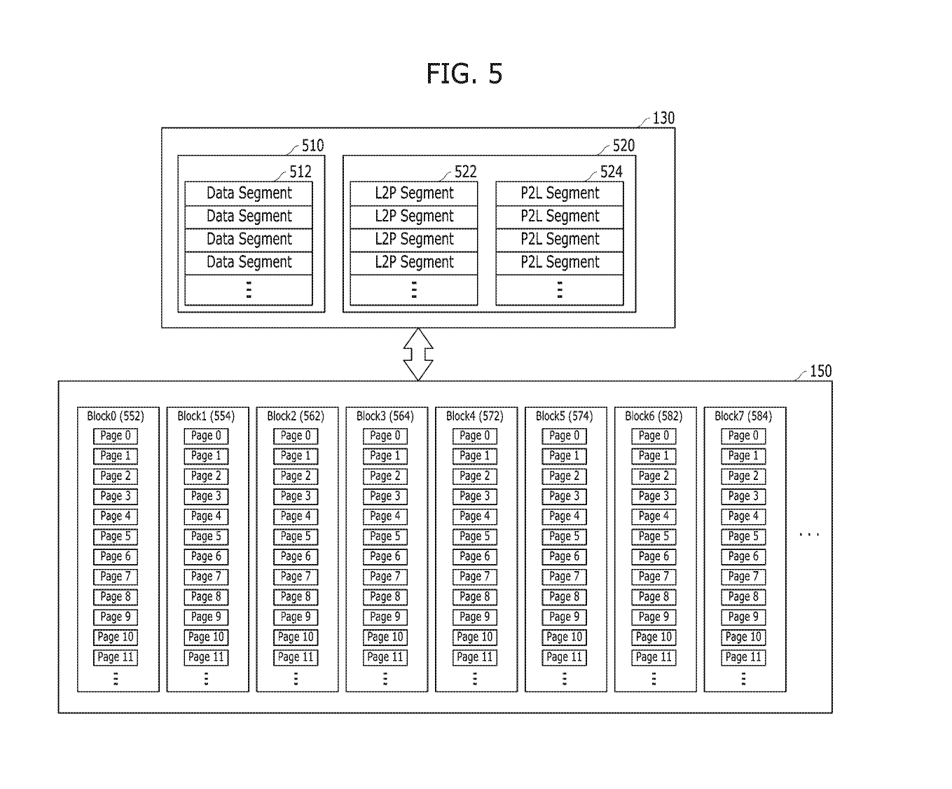

FIGS. 5 to 9 illustrate an example of a data processing operation when a plurality of command operations corresponding to a plurality of commands are performed in the memory system 110 in accordance with an embodiment of the present invention. In this embodiment of the present invention, for the sake of convenience in description, a case in which a plurality of commands are received from the host 102 and command operations corresponding to the received commands are performed in the memory system 110 of FIG. 1 may be taken as an example and described in detail. For example, a case in which a plurality of write commands may be received from the host 102 and program operations corresponding to the write commands may be performed, or a plurality of read commands may be received from the host 102 and read operations corresponding to the read commands may be performed, or a plurality of erase commands may be received from the host 102 and erase operations corresponding to the erase commands may be performed, or a plurality of write commands and a plurality of read commands and a plurality of erase commands may be received together from the host 102 and program operations, read operations and erase operations corresponding to the write commands, the read commands and the erase commands may be performed may be taken as an example and described in detail.

In other words, in the memory system in accordance with the embodiment of the present invention, a case in which write data corresponding to a plurality of write commands received from the host 102 are stored in a buffer/cache included in the memory 144 of the controller 130, and then the data stored in the buffer/cache are programmed and stored in a plurality of memory blocks included in the memory device 150 (in short, program operations are performed), and also map data corresponding to the program operations are updated into the memory device 150 and then the updated map data are stored in the memory blocks included in the memory device 150 is taken as an example and described in the embodiment of the present invention. In short, a case in which program operations corresponding to a plurality of write commands received from the host 102 are performed is taken as an example and described. Also, a case in which when a plurality of read commands are received from the host 102 for the data stored in the memory device 150, the data corresponding to the read commands are read from the memory device 150 by detecting the map data for the data corresponding to the read commands and the read data are stored in the buffer/cache included in the memory 144 of the controller 130 and the data stored in the buffer/cache are transferred to the host 102 is taken as an example and described in the embodiment of the present invention. In short, a case in which read operations corresponding to the read commands received from the host 102 are performed is taken as an example and described in the embodiment of the present invention. Also, a case in which when a plurality of erase commands are received from the host 102 for the memory blocks included in the memory device 150, the memory blocks corresponding to the erase commands are detected and the data stored in the detected memory blocks are erased and the map data corresponding to the erased data are updated and the updated map data are stored in the memory blocks included in the memory device 150 is taken as an example and described in the embodiment of the present invention. In short, a case in which erase operations corresponding to the erase commands received from the host 102 are performed is taken as an example and described in the embodiment of the present invention.

Herein, in the embodiment of the present invention for the sake of convenience in description, the command operations performed in the memory system 110 are performed by the controller 130. However, this is not more than an example and, as described above, the processor 134 included in the controller 130, for example, the FTL, may perform the command operations. Also, in this embodiment of the present invention, the controller 130 may program and store the user data corresponding to the write commands received from the host 102 and metadata in some memory blocks among the memory blocks included in the memory device 150, read the user data corresponding to the read commands received from the host 102, the metadata from the memory blocks storing the user data and the metadata among the memory blocks included in the memory device 150, and transfer the read user data and metadata to the host 102, or erase the user data corresponding to the erase commands received from the host 102 and the metadata from the memory blocks storing the user data and the metadata among the memory blocks included in the memory device 150.

Herein, the metadata may include a first map data including Logical to Physical (L2P) information (which is called logical information, hereafter) for the data stored in memory blocks through a program operation, and a second map data including Physical to Logical (P2L) information (which is called physical information, hereafter). Also, the metadata may include information on the command data corresponding to a command received from the host 102, information on a command operation corresponding to the command, information on the memory blocks of the memory device 150 where the command operation is performed, and information on the map data corresponding to the command operation. In other words, the metadata may include all the other informations and data except the user data corresponding to a command received from the host 102.

According to the embodiment of the present invention, the controller 130 may perform command operations corresponding to a plurality of commands received from the host 102. For example, when the controller 130 receives write commands from the host 102, the controller 130 may perform program operations corresponding to the write commands. Herein, the controller 130 may program and store user data corresponding to the write commands in the memory blocks of the memory device 150, such as empty memory blocks where an erase operation is performed, open memory blocks, or free memory blocks. Also, the controller 130 may program and store mapping information which are first map data including an L2P map table or an L2P map list containing logical information, between the logical addresses and the physical addresses for the user data stored in the memory blocks and mapping information which are second map data including a P2L map table or a P2L map list containing physical information, between the physical addresses and the logical addresses for the memory blocks storing the user data in the empty memory blocks, open memory blocks, or free memory blocks among the memory blocks included in the memory device 150.

When the controller 130 receives write commands from the host 102, the controller 130 may program and store user data corresponding to the write commands in the memory blocks and store metadata that includes the first map data and the second map data for the user data stored in the memory blocks in memory blocks. Particularly, since data segments of the user data are stored in the memory blocks of the memory device 150, the controller 130 may generate and update meta segments of the meta data, which are map segments of map data including L2P segments of the first map data and P2L segments of the second map data, and store them in the memory blocks of the memory device 150. Herein, the map segments stored in the memory blocks of the memory device 150 may be loaded onto the memory 144 of the controller 130 to be updated.

Also, when the controller 130 receives a plurality of read commands from the host 102, the controller 130 may read out the read data corresponding to the read commands from the memory device 150, store the read data in the buffer/cache included in the memory 144 of the controller 130, transfer the data stored in the buffer/cache to the host 102. In this way, read operations corresponding to the read commands may be performed.

Also, when the controller 130 receives a plurality of erase commands from the host 102, the controller 130 may detect memory blocks of the memory device 150 that correspond to the erase commands and perform erase operations onto the detected memory blocks.

Referring to FIG. 5, the controller 130 may perform command operations corresponding to a plurality of commands received from the host 102. For example, the controller 130 may perform program operations corresponding to a plurality of write commands received from the host 102. Herein, the controller 130 may program and store user data corresponding to the write commands in memory blocks 552, 554, 562, 564, 572, 574, 582 and 584 of the memory device 150, and generate and update metadata for the user data when the program operation is performed onto the memory blocks 552, 554, 562, 564, 572, 574, 582 and 584, and then store the generated and updated metadata in the memory blocks 552, 554, 562, 564, 572, 574, 582 and 584 of the memory device 150.

Herein, the controller 130 may generate and update information, for example, the first map data and the second map data, representing that the user data are stored in the pages included in the memory blocks 552, 554, 562, 564, 572, 574, 582 and 584 of the memory device 150 and store the generated and updated information in the pages included in the memory blocks 552, 554, 562, 564, 572, 574, 582 and 584 of the memory device 150. In other words, the controller 130 may generate and update logical segments of the first map data, which include L2P segments, and physical segments of the second map data, which include PH segments, and store the generated and updated logical segments in the pages included in the memory blocks 552, 554, 562, 564, 572, 574, 582 and 584 of the memory device 150.

For example, the controller 130 may cache and buffer the user data corresponding to the write commands received from the host 102 in the first buffer 510 included in the memory 144 of the controller 130, in other words, the controller 130 may store the data segments 512 of the user data in the first buffer 510, which is a data buffer/cache, and store the data segments 512 stored in the first buffer 510 in the pages included in the memory blocks 552, 554, 562, 564, 572, 574, 582 and 584 of the memory device 150. Since the data segments 512 of the user data corresponding to the write commands received from the host 102 are programmed and stored in the pages included in the memory blocks 552, 554, 562, 564, 572, 574, 582 and 584 of the memory device 150, the controller 130 may generate and update the first map data and the second map data and store them in the second buffer 520 included in the memory 144 of the controller 130. In short, the controller 130 may store the L2P segments 522 of the first map data and the P2L segments 524 of the second map data for the user data in the second buffer 520, which is a map buffer/cache. Herein, as described above, the L2P segments 522 of the first map data and the P2L segments 524 of the second map data or a map list for the L2P segments 522 of the first map data and a map list for the P2L segments 524 of the second map data may be stored in the second buffer 520 in the memory 144 of the controller 130. Also, the controller 130 may store the L2P segments 522 of the first map data and the P2L segments 524 of the second map data that are stored in the second buffer 520 in the pages stored in the memory blocks 552, 554, 562, 564, 572, 574, 582 and 584 of the memory device 150.

The controller 130 may perform command operations corresponding to a plurality of commands received from the host 102. For example, the controller 130 may perform read operations corresponding to a plurality of read commands received from the host 102. Herein, the controller 130 may load and check out the map segments of the map data for the user data corresponding to the read commands, for example, the L2P segments 522 of the first map data and the P2L segments 524 of the second map data, onto the second buffer 520, and then read the user data stored in the pages of the corresponding memory blocks among the memory blocks 552, 554, 562, 564, 572, 574, 582 and 584 of the memory device 150, store the data segments 512 of the read user data in the first buffer 510, and transfer them to the host 102.

The controller 130 may perform command operations corresponding to a plurality of commands received from the host 102. That is, the controller 130 may perform erase operations corresponding to a plurality of erase commands received from the host 102. Herein, the controller 130 may detect memory blocks corresponding to the erase commands among the memory blocks 552, 554, 562, 564, 572, 574, 582 and 584 of the memory device 150, and perform the erase operations onto the detected memory blocks.

When a background operation, such as a garbage collection operation or a wear-leveling operation, for example, an operation of copying data or swapping data from the memory blocks included in the memory device 150 is performed, the controller 130 may store the data segments 512 of the corresponding user data in the first buffer 510, store the map segments 522 and 524 of the map data corresponding to the user data in the second buffer 520, and perform the garbage collection operation or the wear-leveling operation.

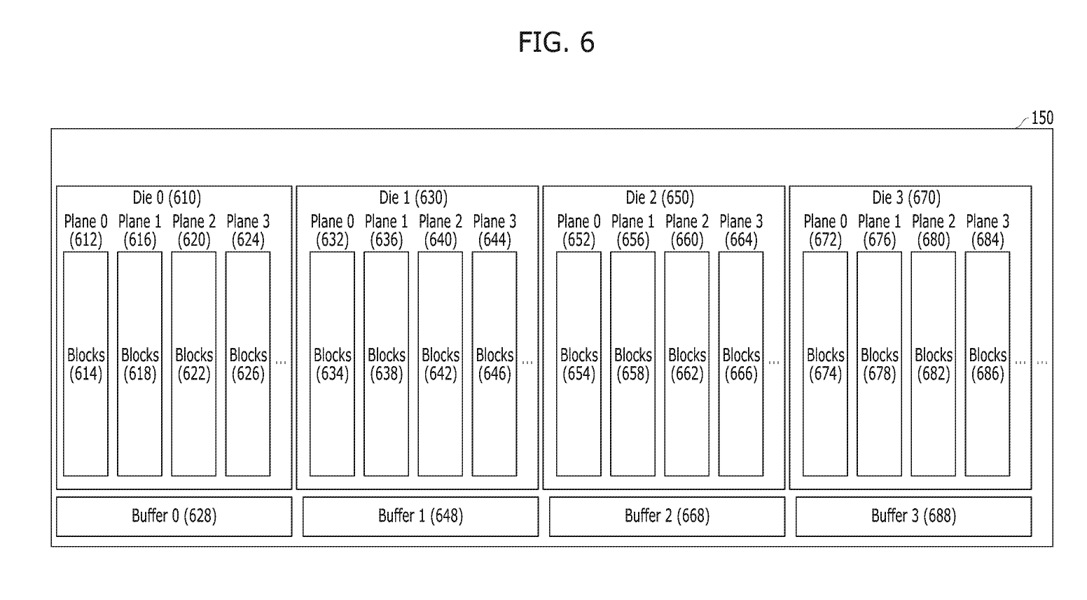

Referring to FIG. 6, the memory device 150 may include a plurality of memory dies, for example, a memory die 0 610, a memory die 1 630, a memory die 2 650, and a memory die 3 670. Each of the memory dies 610, 630, 650 and 670 may include a plurality of planes. For example, the memory die 0 610 may include a plane 0 612, a plane 1 616, a plane 2 620 and a plane 3 624. The memory die 1 630 may include a plane 0 632, a plane 1 636, a plane 2 640 and a plane 3 644. The memory die 2 650 may include a plane 0 652, a plane 1 656, a plane 2 660 and a plane 3 664. The memory die 3 670 may include a plane 0 672, a plane 1 676, a plane 2 680 and a plane 3 684. Each of the planes 612, 616, 620, 624, 632, 636, 640, 644, 652, 656, 660, 664, 672, 676, 680 and 684 of the memory dies 610, 630, 650 and 670 included in the memory device 150 may include a plurality of memory blocks 614, 618, 622, 626, 634, 638, 642, 646, 654, 658, 662, 666, 674, 678, 682 and 686. For example, as described earlier with reference to FIG. 2, each of the planes 612, 616, 620, 624, 632, 636, 640, 644, 652, 656, 660, 664, 672, 676, 680 and 684 may include N blocks Block 0, Block 1, . . . , Block N-1 including a plurality of pages, such as, 2^{M} pages. Also, the memory device 150 may include a plurality of buffers that respectively correspond to the memory dies 610, 630, 650 and 670. For example, the memory device 150 may include a buffer 0 628 corresponding to the memory die 0 610, a buffer 1 648 corresponding to the memory die 1 630, a buffer 2 668 corresponding to the memory die 2 650, and a buffer 3 688 corresponding to the memory die 3 670.

When command operations corresponding to a plurality of commands received from the host 102 are performed, data corresponding to the command operations may be stored in the buffers 628, 648, 668 and 688 included in the memory device 150. For example, when program operations are performed, data corresponding to the program operations may be stored in the buffers 628, 648, 668 and 688, and then stored in the pages included in the memory blocks of the memory dies 610, 630, 650 and 670. When read operations are performed, data corresponding to the read operations may be read from the pages included in the memory blocks of the memory dies 610, 630, 650 and 670, stored in the buffers 628, 648, 668 and 688, and transferred to the host 102 through the controller 130.

Herein, in the embodiment of the present invention, for the sake of convenience in description, a case in which the buffers 628, 648, 668 and 688 included in the memory device 150 exist in the outside of the corresponding memory dies 610, 630, 650 and 670 is taken as an example and described. However, the buffers 628, 648, 668 and 688 included in the memory device 150 may exist in the inside of the corresponding memory dies 610, 630, 650 and 670. Also, the buffers 628, 648, 668 and 688 may correspond to the planes 612, 616, 620, 624, 632, 636, 640, 644, 652, 656, 660, 664, 672, 676, 680 and 684 or the memory blocks 614, 618, 622, 626, 634, 638, 642, 646, 654, 658, 662, 666, 674, 678, 682 and 686 in the memory dies 610, 630, 650 and 670. In the embodiment of the present invention, for the sake of convenience in description, a case in which the buffers 628, 648, 668 and 688 included in the memory device 150 are a plurality of page buffers 322, 324 and 326 included in the memory device 150 is described as an example, as described earlier with reference to FIG. 3. However, the buffers 628, 648, 668 and 688 included in the memory device 150 may be a plurality of caches or a plurality of registers included in the memory device 150.

The memory blocks included in the memory device 150 may be grouped into a plurality of super memory blocks, and then command operations may be performed onto the super memory blocks. Herein, each of the super memory blocks may include a plurality of memory blocks, for example, memory blocks included in a first memory block group and a second memory block group. Herein, when the first memory block group is included in a first plane of a first memory die, the second memory block group may be included in the first plane of the first memory die or a second plane of the first memory die. Moreover, the second memory block group may be included in the planes of the second memory die.

In the memory system in accordance with the embodiment of the present invention, the user data corresponding to the write commands received from the host 102 may be programmed and stored in the pages included in the memory blocks of the memory device 150, and when other write commands are received from the host 102 for the user data stored in the pages of the memory blocks, the user data may be programmed and stored in the pages of other memory blocks of the memory device 150. Herein, the user data stored in the pages of the previous memory blocks may become invalid data, and the pages storing the user data in the memory blocks may become invalid pages.

In the memory system in accordance with the embodiment of the present invention, as program operations corresponding to the write commands received from the host 102 are performed and the memory blocks of the memory device 150 include invalid pages, the controller 130 may perform a garbage collection operation to maximize the utility efficiency of the memory device 150. Herein, the controller 130 may detect valid pages among the memory blocks of the memory device 150 based on the map data for the memory blocks of the memory device 150, and perform the garbage collection operation to generate empty memory blocks, open memory blocks, or free memory blocks based on the parameters of the memory blocks, such as, valid page counts (VPC).

In the memory system in accordance with the embodiment of the present invention, the controller 130 may program the user data corresponding to a write command received from the host 102 in a plurality of pages of some memory blocks among the memory blocks included in the memory device 150. The controller 130 may perform a program operation and store the user data corresponding to the write command received from the host 102 in first pages of first memory blocks. When the controller 130 receives a write command for the user data stored in the first pages of the first memory blocks from the host 102, the controller 130 may perform a program operation for the user data stored in the first pages of the first memory blocks. The controller 130 may store the user data corresponding to the write commands received from the host 102 in other pages of the memory blocks, such as, second pages of the first memory blocks, or in the pages of other memory blocks, such as, first pages of second memory blocks. Herein, the user data stored in the pages of the previous memory blocks, which are the first pages of the first memory blocks, may become invalid data. As a result, the first pages of the first memory blocks may become invalid pages.

In accordance with the embodiment of the present invention, the controller 130 may perform a garbage collection operation in consideration of the valid pages in the memory blocks where program operations are completed, that is, the memory blocks where program operations for the data are performed to all pages. Particularly, the controller 130 may copy and store the valid data of the valid pages included in the memory blocks in other memory blocks that are not programmed with any data, such as, empty memory blocks, open memory blocks, or free memory blocks.

Particularly, in accordance with the embodiment of the present invention, after the controller 130 detects map data and parameters for the memory blocks of the memory device 150, the controller 130 may select source memory blocks among the memory blocks of the memory device 150, and copy and store the valid data stored in the valid pages of the source memory blocks in the pages of target memory blocks. Herein, the controller 130 may detect the map data and the parameters of the memory blocks, for example, closed memory blocks where a program operation is performed among the memory blocks of the memory device 150, select source memory blocks based on the map data and the parameters, and select empty memory blocks, open memory blocks or free memory blocks as the target memory blocks among the memory blocks of the memory device 150. When the controller 130 performs garbage collection operations onto the memory blocks of the memory device 150, the controller 130 may read the map segments for the memory blocks from the memory blocks to detect the valid pages of the memory blocks and select the source memory blocks and perform an operation of loading the read map segments into the memory 144 of the controller 130, which is a map segment loading operation, and an operation of scanning the map segments that are loaded in the memory 144 of the controller 130, which is a map segment scanning operation, and also perform a copy operation and an erase operation for the selected source memory blocks.

Herein, when the controller 130 performs a copy operation onto the source memory blocks, that is, when the controller 130 copies and stores the valid data stored in the valid pages of the source memory blocks into the pages of the target memory blocks, the controller 130 may detect the valid pages of the source memory blocks based on the map data, particularly, the second map data for the source memory blocks and copy the valid data stored in the valid pages into the target memory blocks. When the controller 130 does not normally detect the map segments, that is, P2L segments of the second map data for the source memory blocks, the controller 130 may copy and store the data stored in all the pages of the source memory blocks where the P2L segments are not normally detected into the target memory blocks, and then when the map data for the target memory blocks are updated, the controller 130 may detect validity of the data stored in the target memory blocks, that is, detect whether or not the data stored in the pages of the target memory blocks are valid data, and perform a map update operation only for the valid data.

The controller 130 may perform program operations corresponding to the write commands received from the host 102 in the source memory blocks in a first direction, for example, write and store the data corresponding to the write commands in the first direction, for example, a forward direction, according to the block indices or block numbers of the source memory blocks and the page indices or page numbers of the pages included in each of the source memory blocks, and perform a copy operation from the source memory blocks into the target memory blocks in a second direction, for example, copy and store the data stored in the source memory blocks into the target memory blocks in a reverse direction to the first direction that the program operations are performed in the source memory blocks.

In the memory system in accordance with the embodiment of the present invention, when a garbage collection operation is performed, the source memory blocks and the target memory blocks may be selected among the memory blocks of the memory device 150, and the data stored in the pages of the source memory blocks, particularly, the valid data stored in the valid pages of the source memory blocks, may be copied and stored in the pages included in the target memory blocks. Herein, the data stored in the pages of the source memory blocks through the program operations performed in the first direction may be copied and stored in the pages of the target memory blocks through the copy operation performed in the second direction according to the block indices or block numbers of the memory blocks and the page indices or page numbers of the pages included in each of the memory blocks, and an erase operation may be performed onto the source memory blocks.

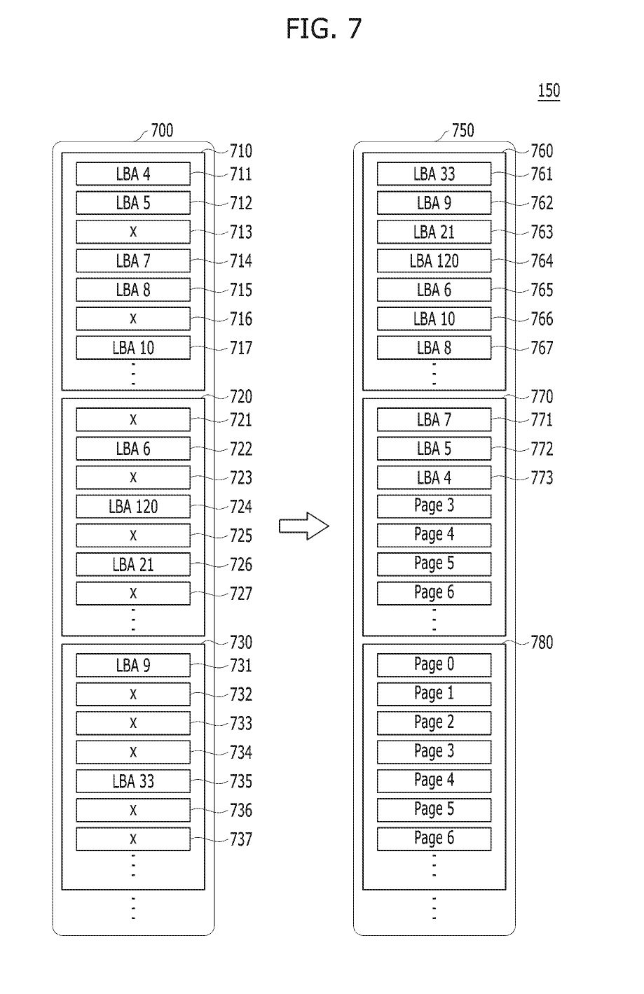

Referring to FIG. 7, the controller 130 may write and store the user data corresponding to a plurality of write commands received from the host 102 in the pages of a plurality of memory blocks included in the memory device 150.

As described above, the memory blocks included in the memory device 150 may include a plurality of pages. When the controller 130 performs a program operation for the user data stored in the memory blocks of the memory device 150, valid pages and invalid pages may be generated in the memory blocks of the memory device 150 as a result of the program operation for the user data performed in the memory blocks of the memory device 150, and the map data for the memory blocks of the memory device 150 may be updated. In the memory system 110 in accordance with the embodiment of the present invention, the controller 130 may detect the map data and the parameters for the memory blocks of the memory device 150, and select the source memory blocks and the target memory blocks among the memory blocks of the memory device 150 based on the map data and the parameters, particularly, the number of the valid pages included in the memory blocks of the memory device 150, such as, the VPC of the memory blocks of the memory device 150, copy and store the data stored in the pages of the source memory blocks, particularly, the valid data stored in the valid pages of the source memory blocks, into the pages of the target memory blocks, and perform an erase operation onto the source memory blocks.

As an example, the controller 130 may select a plurality of source memory blocks 710, 720 and 730 and a plurality of target memory blocks 760, 770 and 780 among the memory blocks included in the memory device 150. The controller 130 may detect the map data and the parameters for the memory blocks included in the memory device 150, particularly, memory blocks, such as, closed memory blocks where a program operation is performed, and group and select the source memory blocks 710, 720 and 730 as a source memory block group 700, that is, a source super memory block 700, based on the map data and the parameters. The controller 130 may group and select the target memory blocks 760, 770 and 780 as a target memory block group 750, that is, a target super memory block 750, among the memory blocks, particularly, empty memory blocks, open memory blocks, or free memory blocks included in the memory device 150.

As described above, the controller 130 may perform the program operations corresponding to the write commands received from the host 102 in the memory blocks, such as, the source memory blocks 710, 720 and 730 of the source super memory block 700 included in the memory device 150. The controller 130 may write and store the data corresponding to the write commands in the source memory blocks 710, 720 and 730. Particularly, the controller 130 may write and store the data corresponding to the write commands in the pages included in the source memory blocks 710, 720 and 730 in the first direction, such as, a forward direction, according to the block indices or block numbers of the memory blocks and the page indices or page numbers of the pages included in each of the memory blocks.

For example, the controller 130 may perform a program operation in the source memory blocks 710, 720 and 730 of the source super memory block 700 in the first direction. The controller 130 may perform a program operation in the forward direction from the first source memory block 710 toward the second source memory block 720 and the third source memory block 730, and in each of the source memory blocks 710, 720 and 730, the controller 130 may perform a program operation in the forward direction from a page 0 711, 721 and 731 toward a page 1 712, 722 and 732, a page 2 713, 723 and 733, and page 3 714, 724 and 734. The controller 130 may update the map segments of the map data for the source memory blocks 710, 720 and 730 as the program operation is performed in the source memory blocks 710, 720 and 730 of the source super memory block 700. The controller 130 may update an L2P segment 1 of a first map data and a P2L segment 1 of a second map data for the first source memory block 710, an L2P segment 2 of a first map data and a P2L segment 2 of a second map data for the second source memory block 720, and an L2P segment 3 of a first map data and a P2L segment 3 of a second map data for the third source memory block 730.

The controller 130 may detect the map segments, such as, L2P segments and the P2L segments, of the map data for the source memory blocks 710, 720 and 730 of the source super memory block 700, and detect valid pages among the pages included in the source memory blocks 710, 720 and 730 based on the L2P segments and the P2L segments. The controller 130 may refer to the L2P segment 1 of the first map data and the P2L segment 1 of the second map data for the first source memory block 710 and detect the page 0 711, the page 1 712, the page 3 714, the page 4 715, and the page 6 717 as valid pages of the first source memory block 710. The controller 130 may refer to the L2P segment 2 of the first map data and the P2L segment 2 of the second map data for the second source memory block 720 and detect the page 1 722, the page 3 724, and the page 5 726 as valid pages of the second source memory block 720. The controller 130 may refer to the L2P segment 3 of the first map data and the P2L segment 3 of the second map data for the third source memory block 730 and detect the page 0 731 and the page 4 735 as valid pages of the third source memory block 730.

The controller 130 may copy and store the data stored in the valid pages of the source memory blocks 710, 720 and 730 into the pages included in the target memory blocks 760, 770 and 780. Particularly, the controller 130 may perform a copy operation from the source super memory block 700 including the source memory blocks 710, 720 and 730 into the target super memory block 750 including the target memory blocks 760, 770 and 780 in the second direction. The second direction may be a reverse direction to the first direction that the program operations are performed in the source super memory block 700, and the controller 130 may copy and store the data stored in the source super memory block 700 into the target super memory block 750 in the second direction.

For example, the controller 130 may perform a copy operation for the data stored in the valid pages in the source memory blocks 710, 720 and 730 of the source super memory block 700 in the second direction according to the block indices or block numbers of the memory blocks and the page indices or page numbers of the pages included in each of the memory blocks. The controller 130 may perform a copy operation in the reverse direction from the third source memory block 730 toward the second source memory block 720 and the first memory block 710, and perform a copy operation in the reverse direction in the source memory blocks 710, 720 and 730 from the page 6 737, 727 and 717 toward the page 5 736, 726 and 716, the page 4 735, 725 and 715 and the page 3 734, 724 and 714.

The controller 130 may copy and store the data stored in the valid pages of the source memory blocks 710, 720 and 730 of the source super memory block 700 into the pages of the target memory blocks 760, 770 and 780 of the target super memory block 750. Particularly, the controller 130 may perform a copy operation in the reverse direction to the first direction that the program operation is performed in the source super memory block 700. Herein, the controller 130 may copy and store Logical Block Address (LBA) 33 data stored in the page 4 735 of the third source memory block 730 in a page 0 761 of the first target memory block 760, and copy and store LBA9 data stored in the page 0 731 of the third source memory block 730 in a page 1 762 of the first target memory block 760. The controller 130 may copy and store LBA21 data stored in the page 5 726 of the second memory block 720 in a page 2 763 of the first target memory block 760, and copy and store LBA120 data stored in the page 3 724 of the second memory block 720 in a page 3 764 of the first target memory block 760, and copy and store LBA6 data stored in the page 1 722 of the second memory block 720 in a page 4 765 of the first target memory block 760. The controller 130 may copy and store LBA10 data stored in the page 6 717 of the first memory block 710 in a page 5 766 of the first target memory block 760, copy and store LBA8 data stored in the page 4 715 of the first memory block 710 in a page 6 767 of the first target memory block 760, copy and store LBA7 data stored in the page 3 714 of the first memory block 710 in a page 0 771 of the second target memory block 770, copy and store LBA5 data stored in the page 1 712 of the first memory block 710 in a page 1 772 of the second target memory block 770, and copy and store LBA4 data stored in the page 0 711 of the first memory block 710 in a page 2 773 of the second target memory block 770.

Also, as the data stored in the source super memory block 700 is copied and stored in the target super memory block 750, the controller 130 may perform a map update operation onto the target memory blocks 760, 770 and 780 of the target super memory block 750. The controller 130 may update the L2P segment 1 of the first map data and the P2L segment 1 of the second map data for the first target memory block 760, the L2P segment 2 of the first map data and the P2L segment 2 of the second map data for the second target memory block 770, and the L2P segment 3 of the first map data and the P2L segment 3 of the second map data for the third target memory block 780.

The controller 130 may copy and store the data stored in the valid pages of the source super memory block 700 in the target super memory block 750, and then perform an erase operation onto the source super memory block 700.

In the memory system in accordance with the embodiment of the present invention, the reliability of the data stored in the memory blocks of the memory device 150 may be improved and the utility efficiency of the memory device 150 may be improved through a garbage collection operation by performing the program operations in the first direction and performing the copy operation in the second direction onto the memory blocks included in the memory device 150.

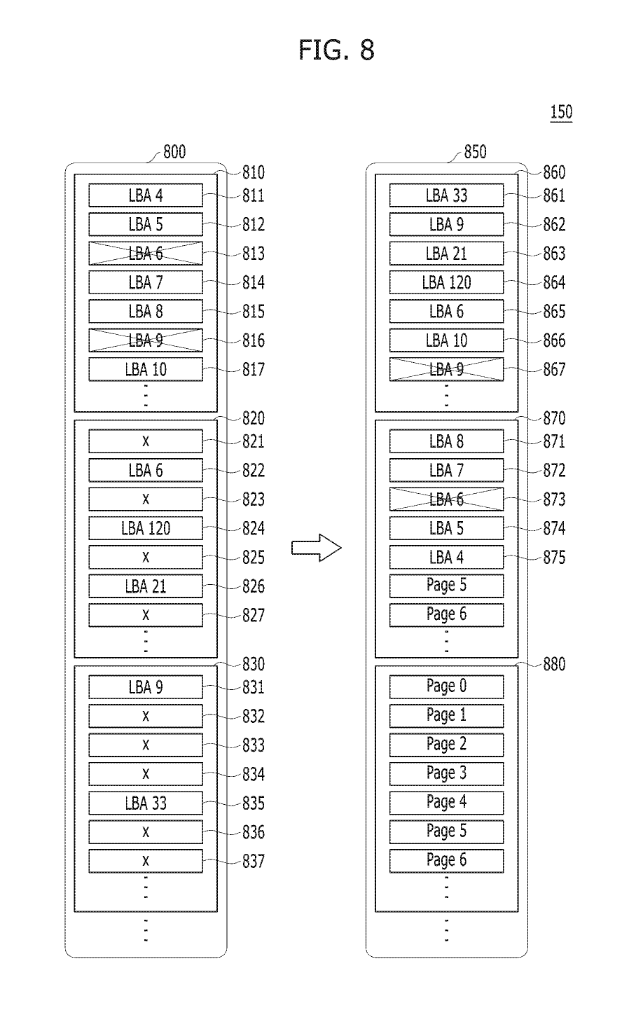

Referring to FIG. 8, the controller 130 may write and store the user data corresponding to a plurality of write commands received from the host 102 in the pages that are included in the memory blocks included in the memory device 150.

Herein, as described above, each of the memory blocks included in the memory device 150 may include a plurality of pages, and when the controller 130 performs a program operation for the user data stored in the memory blocks of the memory device 150, valid pages and invalid pages may be generated in the memory blocks of the memory device 150 as a result of the performance of the program operation for the user data in the memory blocks of the memory device 150, and an update operation of updating the map data for the memory blocks of the memory device 150 may be performed. In the memory system 110 in accordance with the embodiment of the present invention, the controller 130 may detect the map data and parameters for the memory blocks of the memory device 150, select source memory blocks and target memory blocks among the memory blocks of the memory device 150 based on the map data and the parameters, particularly, the number of the valid pages included in the memory blocks of the memory device 150, such as, the VPC of the memory blocks of the memory device 150, copy and store the data stored in the pages of the source memory blocks, particularly, the valid data stored in the valid pages of the source memory blocks, into the pages of the target memory blocks, and perform an erase operation onto the source memory blocks.

For example, the controller 130 may select a plurality of source memory blocks 810, 820 and 830 and a plurality of target memory blocks 860, 870 and 880 among the memory blocks included in the memory device 150. The controller 130 may detect the map data and the parameters for the memory blocks included in the memory device 150, particularly, memory blocks, such as, closed memory blocks where a program operation is performed, and group and select the source memory blocks 810, 820 and 830 as a source memory block group 800, that is, a source super memory block 800, based on the map data and the parameters. Also, the controller 130 may group and select the target memory blocks 860, 870 and 880 as a target memory block group 850, that is, a target super memory block 850, among the memory blocks, particularly, empty memory blocks, open memory blocks, or free memory blocks included in the memory device 150.

As described above, the controller 130 may perform the program operations corresponding to the write commands received from the host 102 in the memory blocks, such as, the source memory blocks 810, 820 and 830 of the source super memory block 800 included in the memory device 150. The controller 130 may write and store the data corresponding to the write commands in the source memory blocks 810, 820 and 830. Particularly, the controller 130 may write and store the data corresponding to the write commands in the pages included in the source memory blocks 810, 820 and 830 in the first direction, such as, a forward direction, according to the block indices or block numbers of the memory blocks and the page indices or page numbers of the pages included in each of the memory blocks.

For example, the controller 130 may perform a program operation in the source memory blocks 810, 820 and 830 of the source super memory block 800 in the first direction. The controller 130 may perform a program operation in the forward direction from the first source memory block 810 toward the second source memory block 820 and the third source memory block 830, and in each of the source memory blocks 810, 820 and 830, the controller 130 may perform a program operation in the forward direction from a page 0 811, 821 and 831 toward a page 1 812, 822 and 832, a page 2 813, 823 and 833, and page 3 814, 824 and 834. The controller 130 may update the map segments of the map data for the source memory blocks 810, 820 and 830 as the program operation is performed in the source memory blocks 810, 820 and 830 of the source super memory block 800. The controller 130 may update an L2P segment 1 of a first map data and a P2L segment 1 of a second map data for the first source memory block 810, an L2P segment 2 of a first map data and a

P2L segment 2 of a second map data for the second source memory block 820, and an L2P segment 3 of a first map data and a P2L segment 3 of a second map data for the third source memory block 830.

The controller 130 may detect the map segments, that is, L2P segments and the P2L segments, of the map data for the source memory blocks 810, 820 and 830 of the source super memory block 800, and detect valid pages among the pages included in the source memory blocks 810, 820 and 830 based on the L2P segments and the P2L segments. The controller 130 may refer to the L2P segment 1 of the first map data and the P2L segment 1 of the second map data for the first source memory block 810 and detect the page 0 811, the page 1 812, the page 3 814, the page 4 815, and the page 6 817 as valid pages of the first source memory block 810. The controller 130 may refer to the L2P segment 2 of the first map data and the P2L segment 2 of the second map data for the second source memory block 820 and detect the page 1 822, the page 3 824, and the page 5 826 as valid pages of the second source memory block 820. The controller 130 may refer to the L2P segment 3 of the first map data and the P2L segment 3 of the second map data for the third source memory block 830 and detect the page 0 831 and the page 4 835 as valid pages of the third source memory block 830.

The controller 130 may copy and store the data stored in the valid pages of the source memory blocks 810, 820 and 830 into the pages included in the target memory blocks 860, 870 and 880. Particularly, the controller 130 may perform a copy operation from the source super memory block 800 including the source memory blocks 810, 820 and 830 into the target super memory block 850 including the target memory blocks 860, 870 and 880 in the second direction. The second direction may be a reverse direction to the first direction that the program operations are performed in the source super memory block 800, and the controller 130 may copy and store the data stored in the source super memory block 800 into the target super memory block 850 in the second direction.

For example, the controller 130 may perform a copy operation for the data stored in the valid pages in the source memory blocks 810, 820 and 830 of the source super memory block 800 in the second direction according to the block indices or block numbers of the memory blocks and the page indices or page numbers of the pages included in each of the memory blocks. The controller 130 may perform a copy operation in the reverse direction from the third source memory block 830 toward the second source memory block 820 and the first memory block 810, and perform a copy operation in the reverse direction in the source memory blocks 810, 820 and 830 from the page 6 837, 827 and 817 toward the page 5 836, 826 and 816, the page 4 835, 825 and 815, and the page 3 834, 824 and 814.

The controller 130 may copy and store the data stored in the valid pages of the source memory blocks 810, 820 and 830 of the source super memory block 800 into the pages of the target memory blocks 860, 870 and 880 of the target super memory block 850. Particularly, the controller 130 may perform a copy operation in the reverse direction to the first direction that the program operation is performed in the source super memory block 800. As described above, when the controller 130 detects the map segments, that is, L2P segments and P2L segments of the map data for the source memory blocks 810, 820 and 830 of the source super memory block 800 and the controller 130 does not normally detect the map segments, such as, P2L segments of arbitrary source memory blocks, the controller 130 may copy and store the data stored in all the pages of the source memory blocks where the P2L segments are not normally detected into the target super memory block 850. When the map data for the target memory blocks are updated, the controller 130 may detect validity of the data stored in the target super memory block 850, that is, detect whether or not the data stored in the pages of the target super memory block 850 are valid data, and perform a map update operation only for the valid data. For the sake of convenience in description, a case in which the map segments, particularly the P2L segments, for the first source memory block 810 are not normally detected among the source memory blocks 810, 820 and 830 of the source super memory block 800 in accordance with the embodiment of the present invention will be described in detail by taking an example.

For example, as described above, the controller 130 may refer to the L2P segment 3 of the first map data and the P2L segment 3 of the second map data for the third source memory block 830 and detect the page 0 831 and the page 4 835 as valid pages of the third source memory block 830. As a result, the controller 130 may copy and store LBA33 data stored in the page 4 835 of the third source memory block 830 in a page 0 861 of the first target memory block 860, and copy and store LBA9 data stored in the page 0 831 of the third source memory block 830 in a page 1 862 of the first target memory block 860. The controller 130 may refer to the L2P segment 2 of the first map data and the P2L segment 2 of the second map data for the second source memory block 820 and detect the page 1 822, the page 3 824, and the page 5 826 as valid pages of the second source memory block 820. As a result, the controller 130 may copy and store LBA21 data stored in the page 5 826 of the second memory block 820 in a page 2 863 of the first target memory block 860, copy and store LBA120 data stored in the page 3 824 of the second memory block 820 in a page 3 864 of the first target memory block 860, and copy and store LBA6 data stored in the page 1 822 of the second memory block 820 in a page 4 865 of the first target memory block 860.

Since the controller 130 does not normally detect the L2P segment 1 of the first map data and the P2L segment 1 of the second map data for the first source memory block 810, particularly, controller 130 does not normally detect the P2L segment 1, and thus does not normally detect the page 0 811, the page 1 812, the page 3 814, the page 4 815, and the page 6 817 as valid pages, the controller 130 may copy and store the data stored in all the pages of the first source memory block 810 into the target super memory block 850. In other words, the controller 130 may copy and store the LBA10 data stored in the page 6 817 of the first source memory block 810 into the page 5 866 of the first target memory block 860, and copy and store the LBA9 data stored in the page 5 816 of the first source memory block 810 into the page 6 867 of the first target memory block 860. After the controller 130 copies and stores the data stored in the source super memory block 800 into the first target memory block 860 of the target super memory block 850, the controller 130 may perform a map update operation for the first target memory block 860 of the target super memory block 850. In other words, the controller 130 may update the L2P segment 1 of the first map data and the P2L segment 1 of the second map data for the first target memory block 860.

Herein, the controller 130 may check out whether or not the LBA9 data stored in the page 6 867 of the first target memory block 860 is invalid data through the map update operation for the first target memory block 860 of the target super memory block 850. That is, the controller 130 may detect that the LBA9 data stored in the page 1 862 of the first target memory block 860 is valid data and the LBA9 data stored in the page 6 867 of the first target memory block 860 is invalid data. The controller 130 may detect the LBA33 data stored in the page 0 861, the LBA9 data stored in the page 1 862, the LBA21 data stored in the page 2 863, the LBA120 data stored in the page 3 864, the LBA6 data stored in the page 4 865, and the LBA10 data stored in the page 5 866 as valid data in the first target memory block 860, and perform the map update operation only for the valid data of the first target memory block 860. When the memory system 110 is turned off while the controller 130 performs the map update operation for the first target memory block 860 and then the memory system 110 is turned on again and the memory system 110 receives a read command for the LBA9 data from the host 102, the controller 130 may provide the host 102 with the LBA9 data stored in the page 1 862 of the first target memory block 860 as a normal valid data, and accordingly, read failure may be minimized and thus, read performance in the memory system 110 may be improved.

The controller 130 may copy and store the LBA8 data stored in the page 4 815 of the first source memory block 810 into the page 0 871 of the second target memory block 870, copy and store the LBA7 data stored in the page 3 814 of the first source memory block 810 into the page 1 872 of the second target memory block 870, and copy and store the LBA6 data stored in the page 2 813 of the first source memory block 810 into the page 2 873 of the second target memory block 870. The controller 130 may also copy and store the LBA5 data stored in the page 1 812 of the first source memory block 810 into the page 3 874 of the second target memory block 870, and copy and store the LBA4 data stored in the page 0 811 of the first source memory block 810 into the page 4 875 of the second target memory block 870. After the controller 130 copies and stores the data stored in the source super memory block 800 into the second target memory block 870 of the target super memory block 850, the controller 130 may perform a map update operation for the second target memory block 870 of the target super memory block 850. In other words, the controller 130 may update the L2P segment 1 of the first map data and the P2L segment 1 of the second map data for the second target memory block 870.

The controller 130 may check out whether or not the LBA6 data stored in the page 2 873 of the second target memory block 870 is invalid data through the map update operation for the second target memory block 870 of the target super memory block 850. That is, the controller 130 may detect that the LBA6 data stored in the page 4 865 of the first target memory block 860 is valid data and the LBA6 data stored in the page 2 873 of the second target memory block 870 is invalid data. The controller 130 may detect the LBA8 data stored in the page 0 871, the LBA7 data stored in the page 1 872, the LBA5 data stored in the page 3 874, and the LBA4 data stored in the page 4 875 as valid data in the second target memory block 870, and perform the map update operation only for the valid data of the second target memory block 870. When the memory system 110 is turned off while the controller 130 performs the map update operation for the second target memory block 870 and then the memory system 110 is turned on again and the memory system 110 receives a read command for the LBA6 data from the host 102, the controller 130 may provide the host 102 with the LBA6 data stored in the page 4 865 of the first target memory block 860 as a normal valid data, and accordingly, read failure may be minimized and thus, read performance in the memory system 110 may be improved.

The controller 130 may copy and store the data stored in the pages of the source super memory block 800 in the target super memory block 850, and then perform an erase operation onto the source super memory block 800.

In the memory system in accordance with the embodiment of the present invention, the reliability of the data stored in the memory blocks of the memory device 150 may be improved by performing the program operations in the first direction and performing the copy operation in the second direction onto the memory blocks included in the memory device 150. Particularly, when the memory system 110 is turned off while the controller 130 performs the map update operation and then the memory system 110 is turned on again and the memory system 110 receives a read command from the host 102, the controller 130 may provide the host 102 with a normal valid data, and accordingly, read failure may be minimized and thus, read performance in the memory system 110 may be improved. Also, in the memory system in accordance with the embodiment of the present invention, the utility efficiency of the memory device 150 may be improved through a garbage collection operation.

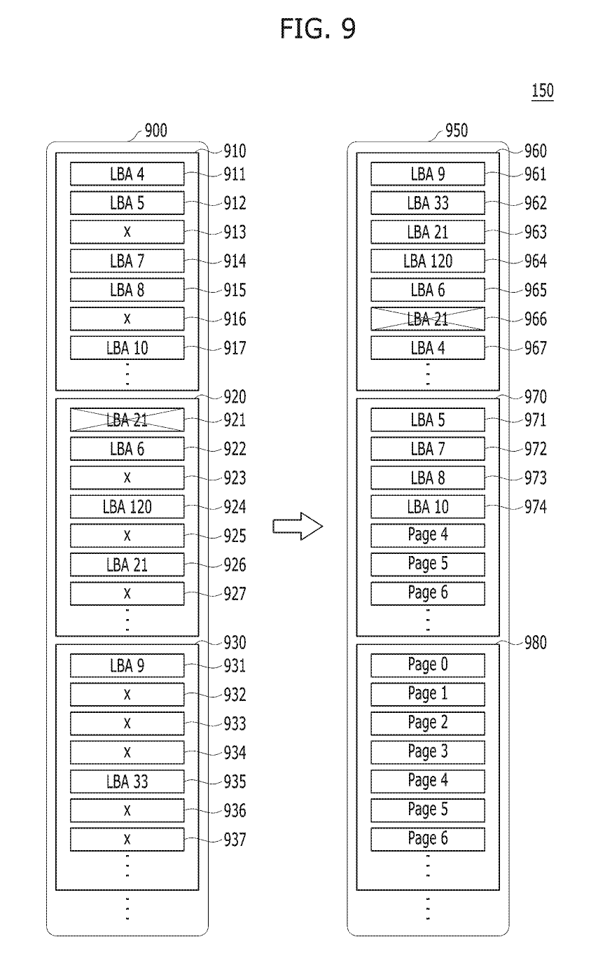

Subsequently, referring to FIG. 9, the controller 130 may write and store the user data corresponding to a plurality of write commands received from the host 102 in the pages that are included in the memory blocks included in the memory device 150.

As described above, each of the memory blocks included in the memory device 150 may include a plurality of pages, and when the controller 130 performs a program operation for the user data stored in the memory blocks of the memory device 150, valid pages and invalid pages may be generated in the memory blocks of the memory device 150 as a result of the performance of the program operation for the user data in the memory blocks of the memory device 150, and an update operation of updating the map data for the memory blocks of the memory device 150 may be performed. In the memory system 110 in accordance with the embodiment of the present invention, the controller 130 may detect the map data and parameters for the memory blocks of the memory device 150, select source memory blocks and target memory blocks among the memory blocks of the memory device 150 based on the map data and the parameters, particularly, the number of the valid pages included in the memory blocks of the memory device 150, such as, the VPC of the memory blocks of the memory device 150, copy and store the data stored in the pages of the source memory blocks, particularly, the valid data stored in the valid pages of the source memory blocks, into the pages of the target memory blocks, and perform an erase operation onto the source memory blocks.

For example, the controller 130 may select a plurality of source memory blocks 910, 920 and 930 and a plurality of target memory blocks 960, 970 and 980 among the memory blocks included in the memory device 150. The controller 130 may detect the map data and the parameters for the memory blocks included in the memory device 150, particularly, memory blocks, for example, closed memory blocks where a program operation is performed, and group and select the source memory blocks 910, 920 and 930 as a source memory block group 900, that is, a source super memory block 900, based on the map data and the parameters. The controller 130 may group and select the target memory blocks 960, 970 and 980 as a target memory block group 950, that is, a target super memory block 950, among the memory blocks, particularly, empty memory blocks, open memory blocks, or free memory blocks included in the memory device 150.

As described above, the controller 130 may perform the program operations corresponding to the write commands received from the host 102 in the memory blocks, for example, the source memory blocks 910, 920 and 930 of the source super memory block 900 included in the memory device 150. The controller 130 may write and store the data corresponding to the write commands in the source memory blocks 910, 920 and 930. Particularly, the controller 130 may write and store the data corresponding to the write commands in the pages included in the source memory blocks 910, 920 and 930 in the first direction, such as, a forward direction, according to the block indices or block numbers of the memory blocks and the page indices or page numbers of the pages included in each of the memory blocks.

For example, the controller 130 may perform a program operation in the source memory blocks 910, 920 and 930 of the source super memory block 900 in the first direction. The controller 130 may perform a program operation in the forward direction from the first source memory block 910 toward the second source memory block 920 and the third source memory block 930, and in each of the source memory blocks 910, 920 and 930, the controller 130 may perform a program operation in the forward direction from a page 0 911, 921 and 931 toward a page 1 912, 922 and 932, a page 2 913, 923 and 933, and page 3 914, 924 and 934. The controller 130 may update the map segments of the map data for the source memory blocks 910, 920 and 930 as the program operation is performed in the source memory blocks 910, 920 and 930 of the source super memory block 900. The controller 130 may update an L2P segment 1 of a first map data and a P2L segment 1 of a second map data for the first source memory block 910, an L2P segment 2 of a first map data and a P2L segment 2 of a second map data for the second source memory block 920, and an L2P segment 3 of a first map data and a P2L segment 3 of a second map data for the third source memory block 930.

The controller 130 may detect the map segments, such as, L2P segments and the P2L segments, of the map data for the source memory blocks 910, 920 and 930 of the source super memory block 900, and detect valid pages among the pages included in the source memory blocks 910, 920 and 930 based on the L2P segments and the P2L segments. The controller 130 may refer to the L2P segment 1 of the first map data and the P2L segment 1 of the second map data for the first source memory block 910 and detect the page 0 911, the page 1 912, the page 3 914, the page 4 915, and the page 6 917 as valid pages of the first source memory block 910. The controller 130 may refer to the L2P segment 2 of the first map data and the P2L segment 2 of the second map data for the second source memory block 920 and detect the page 1 922, the page 3 924, and the page 5 926 as valid pages of the second source memory block 920. The controller 130 may refer to the L2P segment 3 of the first map data and the P2L segment 3 of the second map data for the third source memory block 930 and detect the page 0 931 and the page 4 935 as valid pages of the third source memory block 930.

The controller 130 may copy and store the data stored in the valid pages of the source memory blocks 910, 920 and 930 into the pages included in the target memory blocks 910, 920 and 930. Particularly, the controller 130 may perform a copy operation from the source super memory block 900 including the source memory blocks 910, 920 and 930 into the target super memory block 950 including the target memory blocks 960, 970 and 980 in the second direction. Herein, the second direction may be a reverse direction to the first direction that the program operations are performed in the source super memory block 900, and the controller 130 may copy and store the data stored in the source super memory block 900 into the target super memory block 950 in the second direction.

For example, the controller 130 may perform a copy operation for the data stored in the valid pages in the source memory blocks 910, 920 and 930 of the source super memory block 900 in the second direction according to the block indices or block numbers of the memory blocks and the page indices or page numbers of the pages included in each of the memory blocks. The controller 130 may perform a copy operation in the reverse direction from the third source memory block 930 toward the second source memory block 920 and the first memory block 910, and also perform a copy operation in the reverse direction in the source memory blocks 910, 920 and 930 from the page 6 937, 927 and 917 toward the page 5 936, 926 and 916, the page 4 935, 925 and 915 and the page 3 934, 924 and 914.

The controller 130 may perform a copy operation for the arbitrary source memory blocks where the map segments of the map data are not normally detected among the source memory blocks 910, 920 and 930 in the second direction according to the page indices or page numbers of the pages included in each of the memory blocks, and perform a copy operation for the other source memory blocks where the map segments of the map data are normally detected among the source memory blocks 910, 920 and 930 in the first direction according to the page indices or page numbers of the pages included in each of the memory blocks.

The controller 130 may copy and store the data stored in the valid pages of the source memory blocks 910, 920 and 930 of the source super memory block 900 into the pages of the target memory blocks 960, 970 and 980 of the target super memory block 950. Particularly, the controller 130 may perform a copy operation in the reverse direction to the first direction that the program operation is performed in the source super memory block 900. When the controller 130 detects the map segments, such as, L2P segments and P2L segments of the map data for the source memory blocks 910, 920 and 930 of the source super memory block 900 and the controller 130 does not normally detect the map segments, such as, P2L segments of arbitrary source memory blocks, the controller 130 may copy and store the data stored in all the pages of the source memory blocks where the P2L segments are not normally detected into the target super memory block 950. When the map data for the target super memory block 950 are updated, the controller 130 may detect validity of the data stored in the target super memory block 950, that is, detect whether or not the data stored in the pages of the target super memory block 950 are valid data, and perform a map update operation only for the valid data. For the sake of convenience in description, a case in which the map segments, particularly, P2L segments, for the second source memory block 920 are not normally detected among the source memory blocks 910, 920 and 930 of the source super memory block 900 in accordance with the embodiment of the present invention will be described in detail by taking an example. Also, a case in which the controller 130 performs a copy operation for the second source memory block 920 where the map segments are not normally detected among the source memory blocks 910, 920 and 930 of the source super memory block 900 in the second direction according to the page indices or page numbers and performs a copy operation for the first source memory block 910 and the third source memory block 930 where the map segments are normally detected among the source memory blocks 910, 920 and 930 of the source super memory block 900 in the first direction according to the page indices or page numbers will be taken as an example and described in detail in accordance with the embodiment of the present invention.

For example, as described above, the controller 130 may copy and store the data stored in the source memory blocks 910, 920 and 930 of the source super memory block 900 in the first direction based on the block indices or block numbers of the source memory blocks 910, 920 and 930 included in the source super memory block 900 into the target super memory block 950, and copy and store the data stored in the source memory blocks 910, 920 and 930 of the source super memory block 900 in the first direction or the second direction into the target super memory block 950 based on whether or not the map segments for the source memory blocks 910, 920 and 930, particularly, the P2L segments, are normally detected.

The controller 130 may refer to the L2P segment 3 of the first map data and the P2L segment 3 of the second map data for the third source memory block 930 and detect the page 0 931 and the page 4 935 as valid pages of the third source memory block 930. As a result, the controller 130 may perform a copy operation in the first direction according to the page indices or page numbers. For example, the controller 130 may copy and store LBA9 data stored in the page 0 931 of the third source memory block 930 in a page 0 961 of the first target memory block 960, and copy and store LBA33 data stored in the page 4 935 of the third source memory block 930 in a page 1 962 of the first target memory block 960.

The controller 130 does not normally detect the L2P segment 2 of the first map data and the P2L segment 2 of the second map data for the second source memory block 920. Particularly, the controller 130 does not normally detect the P2L segment 2, and thus does not normally detect the page 1 922, the page 3 924, and the page 5 926 as valid pages. The controller 130 may copy and store the data stored in all the pages of the second source memory block 920 into the target super memory block 950. Herein, the controller 130 may perform a copy operation in the second direction according to the page indices or page numbers. For example, the controller 130 may copy and store the LBA21 data stored in the page 5 926 of the second source memory block 920 into the page 2 963 of the first target memory block 960, and copy and store the LBA120 data stored in the page 3 924 of the second source memory block 920 into the page 3 964 of the first target memory block 960, and copy and store the LBA6 data stored in the page 1 922 of the second source memory block 920 into the page 4 965 of the first target memory block 960, and copy and store the LBA21 data stored in the page 0 921 of the second source memory block 920 into the page 5 966 of the first target memory block 960.

After the controller 130 copies and stores the data stored in the source super memory block 900 into the first target memory block 960 of the target super memory block 950, the controller 130 may perform a map update operation for the first target memory block 960 of the target super memory block 950. In other words, the controller 130 may update the L2P segment 1 of the first map data and the P2L segment 1 of the second map data for the first target memory block 960.

The controller 130 may check out whether or not the LBA21 data stored in the page 5 966 of the first target memory block 960 is invalid data through the map update operation for the first target memory block 960 of the target super memory block 950, that is, the controller 130 may detect that the LBA21 data stored in the page 2 963 of the first target memory block 960 is valid data and the LBA21 data stored in the page 5 966 of the first target memory block 960 is invalid data. The controller 130 may detect the LBA9 data stored in the page 0 961, the LBA33 data stored in the page 1 962, the LBA21 data stored in the page 2 963, the LBA120 data stored in the page 3 964, and the LBA6 data stored in the page 4 965 as valid data in the first target memory block 960, and perform the map update operation only for the valid data of the first target memory block 960. When the memory system 110 is turned off while the controller 130 performs the map update operation for the first target memory block 960 and then the memory system 110 is turned on again and the memory system 110 receives a read command for the LBA21 data from the host 102, the controller 130 may provide the host 102 with the LBA21 data stored in the page 2 963 of the first target memory block 960 as a normal valid data, and accordingly, read failure may be minimized and thus, read performance in the memory system 110 may be improved.

The controller 130 may refer to the L2P segment 1 of the first map data and the P2L segment 1 of the second map data for the first source memory block 910 and detect the page 0 911, the page 2 912, the page 3 914, the page 4 915, and the page 6 917 as valid pages of the first source memory block 910, and accordingly perform a copy operation in the first direction according to the page indices or page numbers. For example, the controller 130 may copy and store the LBA4 data stored in the page 0 911 of the first source memory block 910 into the page 6 967 of the first target memory block 960, copy and store the LBA5 data stored in the page 1 912 of the first source memory block 910 into the page 0 971 of the second target memory block 970, and copy and store the LBA7 data stored in the page 3 914 of the first source memory block 910 into the page 1 972 of the second target memory block 970, copy and store the LBA8 data stored in the page 4 914 of the first source memory block 910 into the page 2 973 of the second target memory block 970, and copy and store the LBA10 data stored in the page 6 917 of the first source memory block 910 into the page 3 974 of the second target memory block 970.

Also, as the controller 130 may copy and store the data stored in the source super memory block 900 into the target super memory block 950, the controller 130 may perform a map update operation for the first target memory block 960. Herein, the controller 130 may update the L2P segment 1 of the first map data and the P2L segment 1 of the second map data for the first target memory block 960, the L2P segment 2 of the first map data and the P2L segment 2 of the second map data for the second target memory block 970, and the L2P segment 3 of the first map data and the P2L segment 3 of the second map data for the third target memory block 980.

The controller 130 may copy and store the data stored in the pages of the source super memory block 900 in the target super memory block 950, and perform an erase operation for the source super memory block 900.

In the memory system in accordance with the embodiment of the present invention, the reliability of the data stored in the memory blocks of the memory device 150 may be improved by performing the program operations in the first direction and performing the copy operation in the second direction onto the memory blocks included in the memory device 150. Particularly, after the memory system 110 is changed into the power-off state while the map update operation is being performed and then the memory system 110 becomes the power-on state, the read performance in the memory system 110 may be improved by providing the host 102 with a normal valid data with respect to the read command received from the host 102 and minimizing read failure. Also, in the memory system in accordance with the embodiment of the present invention, the utility efficiency of the memory device 150 may be improved through a garbage collection operation.

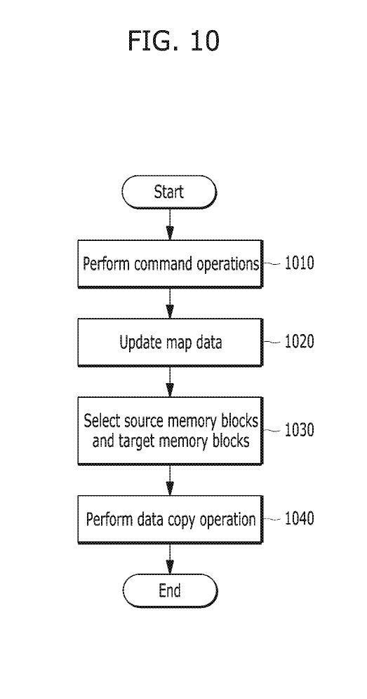

FIG. 10 is a flowchart describing an operation for processing data in the memory system 110 in accordance with the embodiment of the present invention.

Referring to FIG. 10, in step S1010, the memory system 110 may perform command operations corresponding to a plurality of commands received from the host 102. For example, the memory system 110 may perform program operations corresponding to a plurality of write commands received from the host 102. Herein, the memory system 110 may perform the program operations onto a plurality of memory blocks included in the memory device 150 in the first direction according to the block indices or block numbers for the memory blocks included in the memory device 150 and the page indices or page numbers of the pages included in each of the memory blocks.

In step S1020, the memory system 110 may update the map data for the memory blocks of the memory device 150 according to the performance of the command operations. Herein, the valid pages included in each of the memory blocks may be detected.

In step S1030, the memory system 110 may detect the map data and parameters for the memory blocks, and select source memory blocks and target memory blocks among the memory blocks of the memory device 150 based on the map data and the parameters, particularly, the number of the valid pages included in the memory blocks of the memory device 150, such as, the VPC of the memory blocks of the memory device 150.

In step S1040, the memory system 110 may copy and store the data stored in the source memory blocks into the target memory blocks, and then perform an erase operation onto the source memory blocks, that is, perform a garbage collection operation onto the memory blocks of the memory device 150.

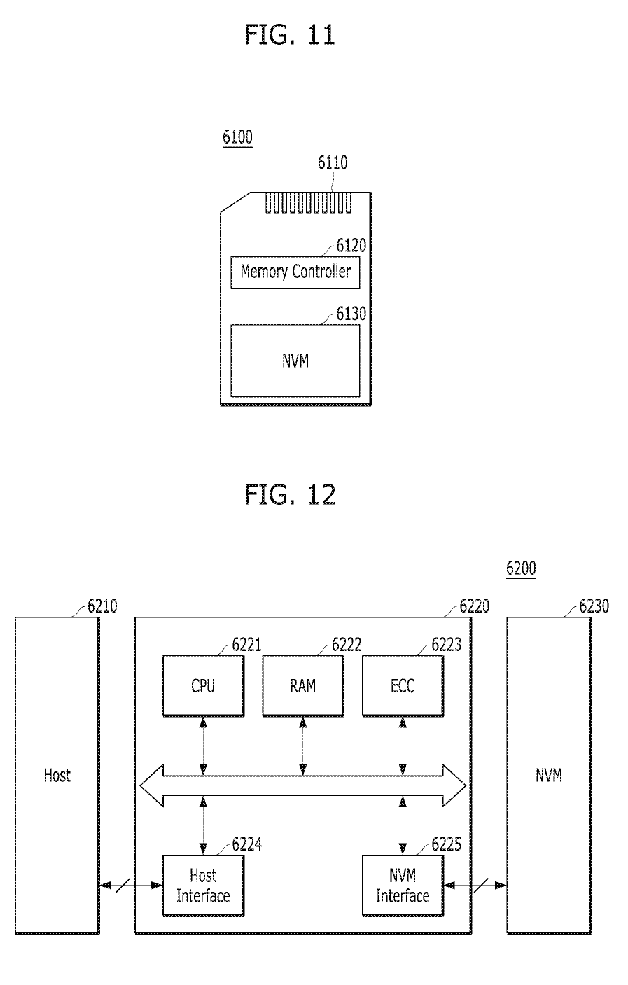

Herein, the memory system 110 may select the source memory blocks and the target memory blocks among the memory blocks of the memory device 150 and respectively group them into a source super memory block and a target super memory block, and then copy and store the data stored in the source super memory block into the target super memory block in the second direction which is different from the first direction that the program operation is performed in the source super memory block. Since the performance of the copy operation in the second direction from the source super memory block toward the target super memory block is described earlier with reference to FIGS. 5 to 9, further description of it will be omitted herein. Hereafter, a data processing system and electronic devices to which the memory system 110 including the memory device 150 and the controller 130 which are described above by referring to FIGS. 1 to 10 is applied will be described in detail with reference to FIGS. 11 to 19.

FIG. 11 is a diagram schematically illustrating another example of the data processing system including the memory system in accordance with an embodiment. FIG. 11 schematically illustrates a memory card system to which the memory system in accordance with an embodiment is applied.

Referring to FIG. 11, the memory card system 6100 may include a memory controller 6120, a memory device 6130 and a connector 6110.

More specifically, the memory controller 6120 may be connected to the memory device 6130 embodied by a nonvolatile memory, and configured to access the memory device 6130. For example, the memory controller 6120 may be configured to control read, write, erase and background operations of the memory device 6130. The memory controller 6120 may be configured to provide an interface between the memory device 6130 and a host, and drive firmware for controlling the memory device 6130. That is, the memory controller 6120 may correspond to the controller 130 of the memory system 110 described with reference to FIG. 1, and the memory device 6130 may correspond to the memory device 150 of the memory system 110 described with reference to FIG. 1.

Thus, the memory controller 6120 may include a RAM, a processing unit, a host interface, a memory interface and an error correction unit.

The memory controller 6120 may communicate with an external device, for example, the host 102 of FIG. 1 through the connector 6110. For example, as described with reference to FIG. 1, the memory controller 6120 may be configured to communicate with an external device through one or more of various communication protocols such as universal serial bus (USB), multimedia card (MMC), embedded MMC (eMMC), peripheral component interconnection (PCI), PCI express (PCIe), Advanced Technology Attachment (ATA), Serial-ATA, Parallel-ATA, small computer system interface (SCSI), enhanced small disk interface (EDSI), Integrated Drive Electronics (IDE), Firewire, universal flash storage (UFS), WIFI and Bluetooth. Thus, the memory system and the data processing system in accordance with an embodiment may be applied to wired/wireless electronic devices or particularly mobile electronic devices.

The memory device 6130 may be implemented by a nonvolatile memory. For example, the memory device 6130 may be implemented by various nonvolatile memory devices such as an erasable and programmable ROM (EPROM), an electrically erasable and programmable ROM (EEPROM), a NAND flash memory, a NOR flash memory, a phase-change RAM (PRAM), a resistive RAM (ReRAM), a ferroelectric RAM (FRAM) and a spin torque transfer magnetic RAM (STT-RAM).

The memory controller 6120 and the memory device 6130 may be integrated into a single semiconductor device. For example, the memory controller 6120 and the memory device 6130 may construct a solid-state driver (SSD) by being integrated into a single semiconductor device. Also, the memory controller 6120 and the memory device 6130 may construct a memory card such as a PC card (PCMCIA: Personal Computer Memory Card International Association), a compact flash (CF) card, a smart media card (e.g., SM and SMC), a memory stick, a multimedia card (e.g., MMC, RS-MMC, MMCmicro and eMMC), an SD card (e.g., SD, miniSD, microSD and SDHC) and a universal flash storage (UFS).

FIG. 12 is a diagram schematically illustrating another example of the data processing system including the memory system in accordance with an embodiment.

Referring to FIG. 12, the data processing system 6200 may include a memory device 6230 having one or more nonvolatile memories and a memory controller 6220 for controlling the memory device 6230. The data processing system 6200 illustrated in FIG. 12 may serve as a storage medium such as a memory card (CF, SD, micro-SD or the like) or USB device, as described with reference to FIG. 1. The memory device 6230 may correspond to the memory device 150 in the memory system 110 illustrated in FIG. 1, and the memory controller 6220 may correspond to the controller 130 in the memory system 110 illustrated in FIG. 1.

The memory controller 6220 may control a read, write or erase operation on the memory device 6230 in response to a request of the host 6210, and the memory controller 6220 may include one or more CPUs 6221, a buffer memory such as RAM 6222, an ECC circuit 6223, a host interface 6224 and a memory interface such as an NVM interface 6225.

The CPU 6221 may control overall operations on the memory device 6230, for example, read, write, file system management and bad page management operations. The RAM 6222 may be operated according to control of the CPU 6221, and used as a work memory, buffer memory or cache memory. When the RAM 6222 is used as a work memory, data processed by the CPU 6221 may be temporarily stored in the RAM 6222. When the RAM 6222 is used as a buffer memory, the RAM 6222 may be used for buffering data transmitted to the memory device 6230 from the host 6210 or transmitted to the host 6210 from the memory device 6230. When the RAM 6222 is used as a cache memory, the RAM 6222 may assist the low-speed memory device 6230 to operate at high speed.

The ECC circuit 6223 may correspond to the ECC unit 138 of the controller 130 illustrated in FIG. 1. As described with reference to FIG. 1, the ECC circuit 6223 may generate an ECC (Error Correction Code) for correcting a fail bit or error bit of data provided from the memory device 6230. The ECC circuit 6223 may perform error correction encoding on data provided to the memory device 6230, thereby forming data with a parity bit. The parity bit may be stored in the memory device 6230. The ECC circuit 6223 may perform error correction decoding on data outputted from the memory device 6230. At this time, the ECC circuit 6223 may correct an error using the parity bit. For example, as described with reference to FIG. 1, the ECC circuit 6223 may correct an error using the LDPC code, BCH code, turbo code, Reed-Solomon code, convolution code, RSC or coded modulation such as TCM or BCM.

The memory controller 6220 may transmit/receive data to/from the host 6210 through the host interface 6224, and transmit/receive data to/from the memory device 6230 through the NVM interface 6225. The host interface 6224 may be connected to the host 6210 through a PATA bus, SATA bus, SCSI, USB, PCIe or NAND interface. The memory controller 6220 may have a wireless communication function with a mobile communication protocol such as WiFi or Long Term Evolution (LTE). The memory controller 6220 may be connected to an external device, for example, the host 6210 or another external device, and then transmit/receive data to/from the external device. In particular, as the memory controller 6220 is configured to communicate with the external device through one or more of various communication protocols, the memory system and the data processing system in accordance with an embodiment may be applied to wired/wireless electronic devices or particularly a mobile electronic device.

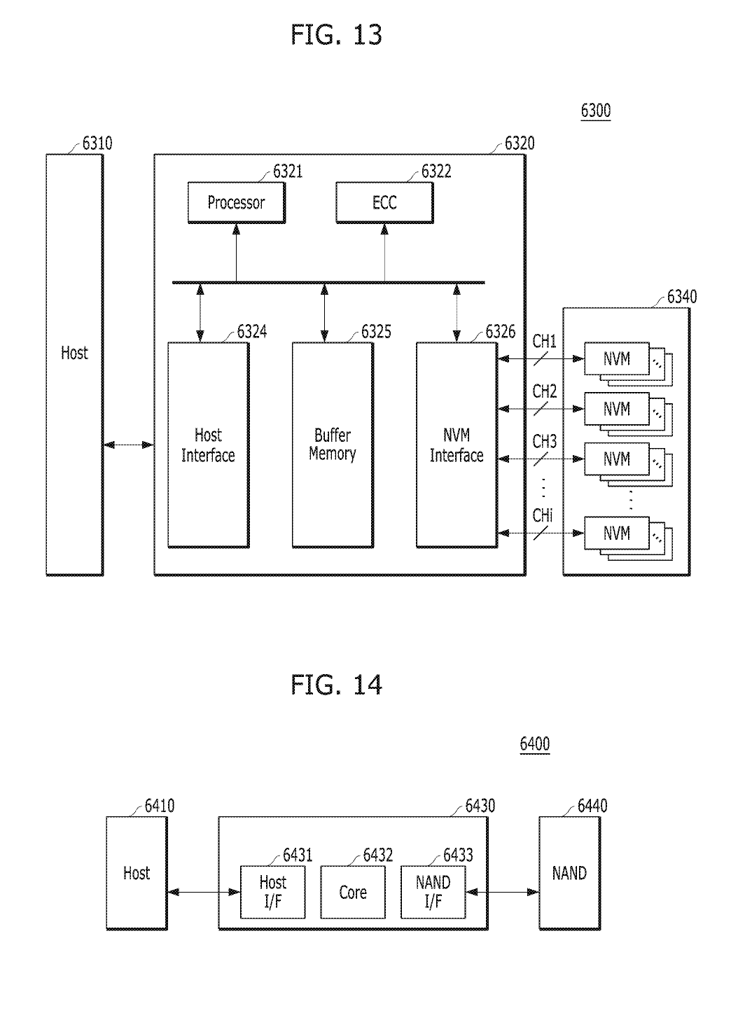

FIG. 13 is a diagram schematically illustrating another example of the data processing system including the memory system in accordance with an embodiment. FIG. 13 schematically illustrates an SSD to which the memory system in accordance with an embodiment is applied.

Referring to FIG. 13, the SSD 6300 may include a controller 6320 and a memory device 6340 including a plurality of nonvolatile memories. The controller 6320 may correspond to the controller 130 in the memory system 110 of FIG. 1, and the memory device 6340 may correspond to the memory device 150 in the memory system of FIG. 1

More specifically, the controller 6320 may be connected to the memory device 6340 through a plurality of channels CH1 to CHi. The controller 6320 may include one or more processors 6321, a buffer memory 6325, an ECC circuit 6322, a host interface 6324 and a memory interface, for example, a nonvolatile memory interface 6326.

The buffer memory 6325 may temporarily store data provided from the host 6310 or data provided from a plurality of flash memories NVM included in the memory device 6340, or temporarily store meta data of the plurality of flash memories NVM, for example, map data including a mapping table. The buffer memory 6325 may be embodied by volatile memories such as DRAM, SDRAM, DDR SDRAM, LPDDR SDRAM and GRAM or nonvolatile memories such as FRAM, ReRAM, STT-MRAM and PRAM. For convenience of description, FIG. 8 illustrates that the buffer memory 6325 exists in the controller 6320. However, the buffer memory 6325 may exist outside the controller 6320.

The ECC circuit 6322 may calculate an ECC value of data to be programmed to the memory device 6340 during a program operation, perform an error correction operation on data read from the memory device 6340 based on the ECC value during a read operation, and perform an error correction operation on data recovered from the memory device 6340 during a failed data recovery operation.

The host interface 6324 may provide an interface function with an external device, for example, the host 6310, and the nonvolatile memory interface 6326 may provide an interface function with the memory device 6340 connected through the plurality of channels.

Furthermore, a plurality of SSDs 6300 to which the memory system 110 of FIG. 1 is applied may be provided to embody a data processing system, for example, RAID (Redundant Array of Independent Disks) system. At this time, the RAID system may include the plurality of SSDs 6300 and a RAID controller for controlling the plurality of SSDs 6300. When the RAID controller performs a program operation in response to a write command provided from the host 6310, the RAID controller may select one or more memory systems or SSDs 6300 according to a plurality of RAID levels, that is, RAID level information of the write command provided from the host 6310 in the SSDs 6300, and output data corresponding to the write command to the selected SSDs 6300. Furthermore, when the RAID controller performs a read command in response to a read command provided from the host 6310, the RAID controller may select one or more memory systems or SSDs 6300 according to a plurality of RAID levels, that is, RAID level information of the read command provided from the host 6310 in the SSDs 6300, and provide data read from the selected SSDs 6300 to the host 6310.

FIG. 14 is a diagram schematically illustrating another example of the data processing system including the memory system in accordance with an embodiment. FIG. 14 schematically illustrates an embedded Multi-Media Card (eMMC) to which the memory system in accordance with an embodiment is applied.

Referring to FIG. 14, the eMMC 6400 may include a controller 6430 and a memory device 6440 embodied by one or more NAND flash memories. The controller 6430 may correspond to the controller 130 in the memory system 110 of FIG. 1, and the memory device 6440 may correspond to the memory device 150 in the memory system 110 of FIG. 1.

More specifically, the controller 6430 may be connected to the memory device 6440 through a plurality of channels. The controller 6430 may include one or more cores 6432, a host interface 6431 and a memory interface, for example, a NAND interface 6433.

The core 6432 may control overall operations of the eMMC 6400, the host interface 6431 may provide an interface function between the controller 6430 and the host 6410, and the NAND interface 6433 may provide an interface function between the memory device 6440 and the controller 6430. For example, the host interface 6431 may serve as a parallel interface, for example, MMC interface as described with reference to FIG. 1. Furthermore, the host interface 6431 may serve as a serial interface, for example, UHS ((Ultra High Speed)-I/UHS-II) interface.

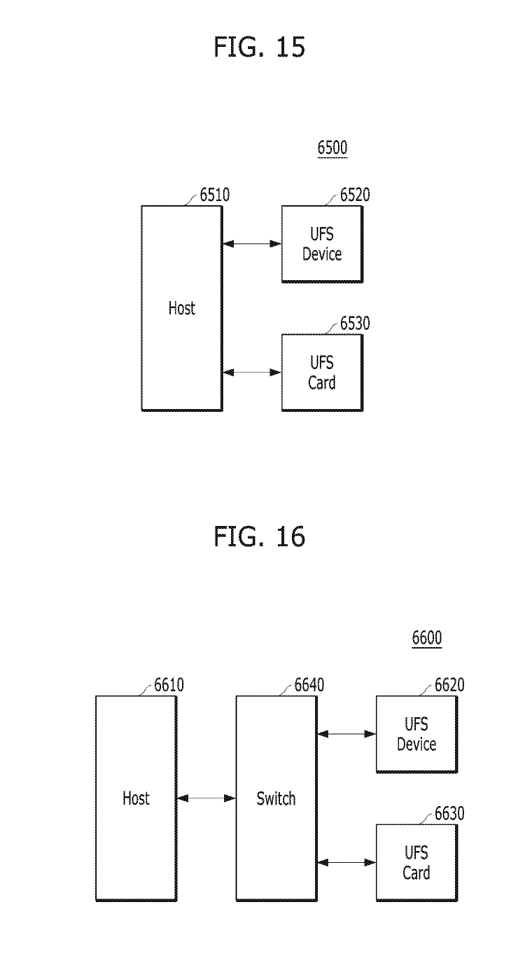

FIGS. 15 to 17 are diagrams schematically illustrating other examples of the data processing system including the memory system in accordance with an embodiment. FIGS. 15 to 18 schematically illustrate UFS (Universal Flash Storage) systems to which the memory system in accordance with an embodiment is applied.

Referring to FIGS. 15 to 18, the UFS systems 6500, 6600, 6700 and 6800 may include hosts 6510, 6610, 6710 and 6810, UFS devices 6520, 6620, 6720 and 6820 and UFS cards 6530, 6630, 6730 and 6830, respectively. The hosts 6510, 6610, 6710 and 6810 may serve as application processors of wired/wireless electronic devices or particularly mobile electronic devices, the UFS devices 6520, 6620, 6720 and 6820 may serve as embedded UFS devices, and the UFS cards 6530, 6630, 6730 and 6830 may serve as external embedded UFS devices or removable UFS cards.

The hosts 6510, 6610, 6710 and 6810, the UFS devices 6520, 6620, 6720 and 6820 and the UFS cards 6530, 6630, 6730 and 6830 in the respective UFS systems 6500, 6600, 6700 and 6800 may communicate with external devices, for example, wired/wireless electronic devices or particularly mobile electronic devices through UFS protocols, and the UFS devices 6520, 6620, 6720 and 6820 and the UFS cards 6530, 6630, 6730 and 6830 may be embodied by the memory system 110 illustrated in FIG. 1. For example, in the UFS systems 6500, 6600, 6700 and 6800, the UFS devices 6520, 6620, 6720 and 6820 may be embodied in the form of the data processing system 6200, the SSD 6300 or the eMMC 6400 described with reference to FIGS. 10 to 12, and the UFS cards 6530, 6630, 6730 and 6830 may be embodied in the form of the memory card system 6100 described with reference to FIG. 11.

Furthermore, in the UFS systems 6500, 6600, 6700 and 6800, the hosts 6510, 6610, 6710 and 6810, the UFS devices 6520, 6620, 6720 and 6820 and the UFS cards 6530, 6630, 6730 and 6830 may communicate with each other through an UFS interface, for example, MIPI M-PHY and MIPI UniPro (Unified Protocol) in MIPI (Mobile Industry Processor Interface). Furthermore, the UFS devices 6520, 6620, 6720 and 6820 and the UFS cards 6530, 6630, 6730 and 6830 may communicate with each other through various protocols other than the UFS protocol, for example, UFDs, MMC, SD, mini-SD, and micro-SD.

In the UFS system 6500 illustrated in FIG. 15, each of the host 6510, the UFS device 6520 and the UFS card 6530 may include UniPro. The host 6510 may perform a switching operation in order to communicate with the UFS device 6520 and the UFS card 6530. In particular, the host 6510 may communicate with the UFS device 6520 or the UFS card 6530 through link layer switching, for example, L3 switching at the UniPro. At this time, the UFS device 6520 and the UFS card 6530 may communicate with each other through link layer switching at the UniPro of the host 6510. In an embodiment, the configuration in which one UFS device 6520 and one UFS card 6530 are connected to the host 6510 has been exemplified for convenience of description. However, a plurality of UFS devices and UFS cards may be connected in parallel or in the form of a star to the host 6410, and a plurality of UFS cards may be connected in parallel or in the form of a star to the UFS device 6520 or connected in series or in the form of a chain to the UFS device 6520.

In the UFS system 6600 illustrated in FIG. 16, each of the host 6610, the UFS device 6620 and the UFS card 6630 may include UniPro, and the host 6610 may communicate with the UFS device 6620 or the UFS card 6630 through a switching module 6640 performing a switching operation, for example, through the switching module 6640 which performs link layer switching at the UniPro, for example, L3 switching. The UFS device 6620 and the UFS card 6630 may communicate with each other through link layer switching of the switching module 6640 at UniPro. In an embodiment, the configuration in which one UFS device 6620 and one UFS card 6630 are connected to the switching module 6640 has been exemplified for convenience of description. However, a plurality of UFS devices and UFS cards may be connected in parallel or in the form of a star to the switching module 6640, and a plurality of UFS cards may be connected in series or in the form of a chain to the UFS device 6620.

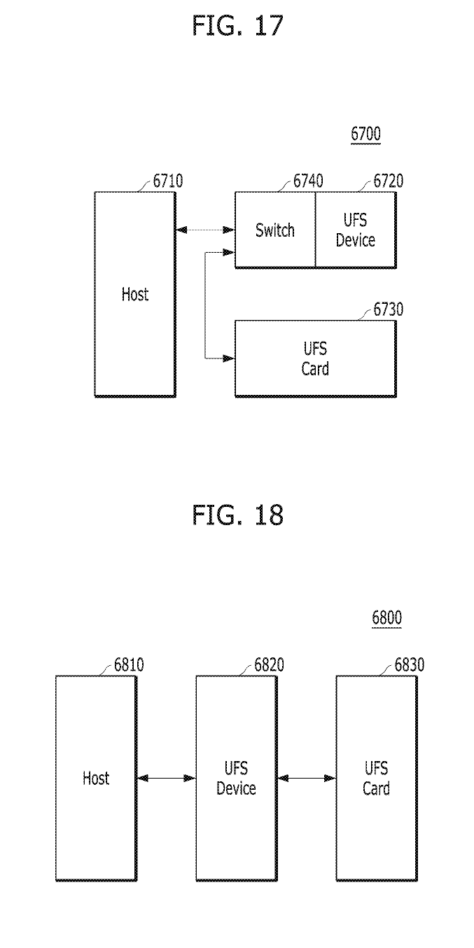

In the UFS system 6700 illustrated in FIG. 17, each of the host 6710, the UFS device 6720 and the UFS card 6730 may include UniPro, and the host 6710 may communicate with the UFS device 6720 or the UFS card 6730 through a switching module 6740 performing a switching operation, for example, through the switching module 6740 which performs link layer switching at the UniPro, for example, L3 switching. At this time, the UFS device 6720 and the UFS card 6730 may communicate with each other through link layer switching of the switching module 6740 at the UniPro, and the switching module 6740 may be integrated as one module with the UFS device 6720 inside or outside the UFS device 6720. In an embodiment, the configuration in which one UFS device 6720 and one UFS card 6730 are connected to the switching module 6740 has been exemplified for convenience of description. However, a plurality of modules each including the switching module 6740 and the UFS device 6720 may be connected in parallel or in the form of a star to the host 6710 or connected in series or in the form of a chain to each other. Furthermore, a plurality of UFS cards may be connected in parallel or in the form of a star to the UFS device 6720.

In the UFS system 6800 illustrated in FIG. 18, each of the host 6810, the UFS device 6820 and the UFS card 6830 may include M-PHY and UniPro. The UFS device 6820 may perform a switching operation in order to communicate with the host 6810 and the UFS card 6830. In particular, the UFS device 6820 may communicate with the host 6810 or the UFS card 6830 through a switching operation between the M-PHY and UniPro module for communication with the host 6810 and the M-PHY and UniPro module for communication with the UFS card 6830, for example, through a target ID (Identifier) switching operation. At this time, the host 6810 and the UFS card 6830 may communicate with each other through target ID switching between the M-PHY and UniPro modules of the UFS device 6820. In an embodiment, the configuration in which one UFS device 6820 is connected to the host 6810 and one UFS card 6830 is connected to the UFS device 6820 has been exemplified for convenience of description. However, a plurality of UFS devices may be connected in parallel or in the form of a star to the host 6810, or connected in series or in the form of a chain to the host 6810, and a plurality of UFS cards may be connected in parallel or in the form of a star to the UFS device 6820, or connected in series or in the form of a chain to the UFS device 6820.

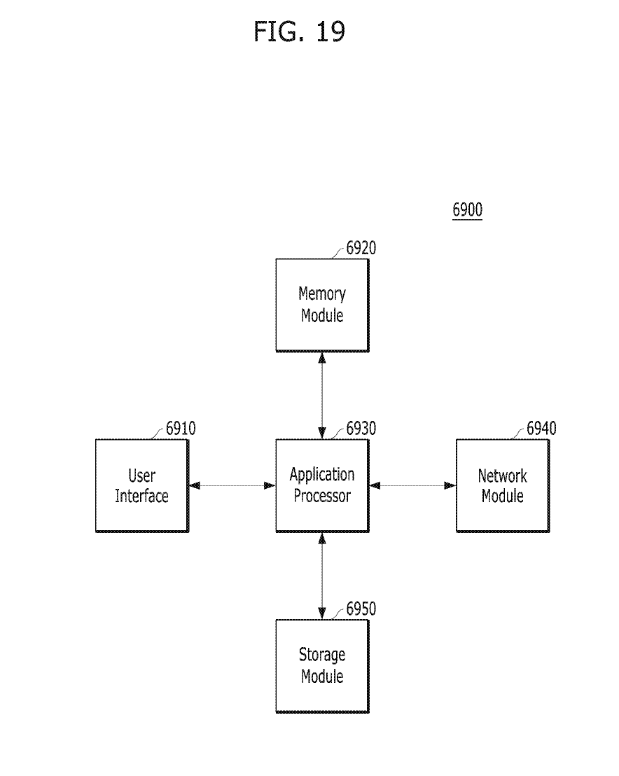

FIG. 19 is a diagram schematically illustrating another example of the data processing system including the memory system in accordance with an embodiment. FIG. 19 is a diagram schematically illustrating a user system to which the memory system in accordance with an embodiment is applied.

Referring to FIG. 19, the user system 6900 may include an application processor 6930, a memory module 6920, a network module 6940, a storage module 6950 and a user interface 6910.

More specifically, the application processor 6930 may drive components included in the user system 6900, for example, an OS, and include controllers, interfaces and a graphic engine which control the components included in the user system 6900. The application processor 6930 may be provided as System-on-Chip (SoC).

The memory module 6920 may be used as a main memory, work memory, buffer memory or cache memory of the user system 6900. The memory module 6920 may include a volatile RAM such as DRAM, SDRAM, DDR SDRAM, DDR2 SDRAM, DDR3 SDRAM, LPDDR SDARM, LPDDR3 SDRAM or LPDDR3 SDRAM or a nonvolatile RAM such as PRAM, ReRAM, MRAM or FRAM. For example, the application processor 6930 and the memory module 6920 may be packaged and mounted, based on POP (Package on Package).

The network module 6940 may communicate with external devices. For example, the network module 6940 may not only support wired communication, but also support various wireless communication protocols such as code division multiple access (CDMA), global system for mobile communication (GSM), wideband CDMA (WCDMA), CDMA-2000, time division multiple access (TDMA), long term evolution (LTE), worldwide interoperability for microwave access (Wimax), wireless local area network (WLAN), ultra-wideband (UWB), Bluetooth, wireless display (WI-DI), thereby communicating with wired/wireless electronic devices or particularly mobile electronic devices. Therefore, the memory system and the data processing system, in accordance with an embodiment of an invention, can be applied to wired/wireless electronic devices. The network module 6940 may be included in the application processor 6930.

The storage module 6950 may store data, for example, data received from the application processor 6930, and then may transmit the stored data to the application processor 6930. The storage module 6950 may be embodied by a nonvolatile semiconductor memory device such as a phase-change RAM (PRAM), a magnetic RAM (MRAM), a resistive RAM (ReRAM), a NAND flash, NOR flash and 3D NAND flash, and provided as a removable storage medium such as a memory card or external drive of the user system 6900. The storage module 6950 may correspond to the memory system 110 described with reference to FIG. 1. Furthermore, the storage module 6950 may be embodied as an SSD, eMMC and UFS as described above with reference to FIGS. 13 to 18.

The user interface 6910 may include interfaces for inputting data or commands to the application processor 6930 or outputting data to an external device. For example, the user interface 6910 may include user input interfaces such as a keyboard, a keypad, a button, a touch panel, a touch screen, a touch pad, a touch ball, a camera, a microphone, a gyroscope sensor, a vibration sensor and a piezoelectric element, and user output interfaces such as a liquid crystal display (LCD), an organic light emitting diode (OLED) display device, an active matrix OLED (AMOLED) display device, an LED, a speaker and a motor.

Furthermore, when the memory system 110 of FIG. 1 is applied to a mobile electronic device of the user system 6900, the application processor 6930 may control overall operations of the mobile electronic device, and the network module 6940 may serve as a communication module for controlling wired/wireless communication with an external device. The user interface 6910 may display data processed by the processor 6930 on a display/touch module of the mobile electronic device, or support a function of receiving data from the touch panel.

According to the embodiments of an invention, the memory system and a method for operating the memory system are capable of processing data with a memory device quickly and stably by minimizing the complexity and performance deterioration of the memory system and maximizing the utility efficiency of the memory device.

While an invention has been described with respect to the specific embodiments, it will be apparent to those skilled in the art that various changes and modifications may be made without departing from the spirit and scope of the invention as defined in the following claims.

What is claimed is:

1. A memory system comprising:
a memory device including a plurality of memory blocks each of which includes a plurality of pages that store data; and
a controller suitable for receiving a plurality of write commands from a host, performing program operations corresponding to the write commands to program data in a first direction in a first memory block group, and copying the programmed data from the first memory block group into a second memory block group in a second direction.

2. The memory system of claim 1,
wherein the first direction is a forward direction according to block indices or block numbers of source memory blocks included in the first memory block group, and page indices or page numbers of pages included in each of the source memory blocks, and
wherein the second direction is a reverse direction to the first direction.

3. The memory system of claim 1, wherein the controller:
detects map data for source memory blocks included in the first memory block group;
detects valid pages included in the source memory blocks based on the map data; and
copies data programmed in the valid pages into target memory blocks of the second memory block group in the second direction.

4. The memory system of claim 3, wherein the controller:
programs data into the first memory block group in the first direction from a first source memory block of the first memory block group toward a second source memory block of the first memory block group; and
programs the data into each of the source memory blocks in the first direction from a first page toward a second page.

5. The memory system of claim 4, wherein the controller:
copies the programmed data in the second direction from the second source memory block toward the first source memory block into the second memory block group; and
copies the programmed data in the second direction from the second page toward the first page of each of the source memory blocks into the second memory block group.

6. The memory system of claim 5, wherein the controller:
stores the copied data into the second memory block group in the first direction from a first target memory block toward a second target memory block in the second memory block group; and
stores the copied data into each of target memory blocks in the first direction from a first page toward a second page.

7. The memory system of claim 1, wherein the controller:
detects map data for source memory blocks included in the first memory block group;
copies data stored in all pages of a first source memory block whose map data are not normally detected into the second memory block group; and
copies data stored in valid pages of a second source memory block whose map data are normally detected into the second memory block group.

8. The memory system of claim 7, wherein the controller:
detects valid data for the data copied from the second source memory block through an update of the map data for the second memory block group; and
updates only the valid data when the map data are updated.

9. The memory system of claim 7, wherein the controller:
copies the programmed data in the second direction from the second source memory block toward the first source memory block into the second memory block group;
copies the programmed data in the first direction from a first page toward a second page in the second source memory block into the second memory block group; and
copies the programmed data in the second direction from a second page toward a first page in the first source memory block into the second memory block group.

10. The memory system of claim 7, wherein the controller:
copies the programmed data in the second direction from the second source memory block toward the first source memory block into the second memory block group; and
copies the programmed data in the second direction from a second page toward a first page in each of the source memory block into the second memory block group.

11. A method for operating a memory system, the method comprising:
receiving a plurality of write commands from a host for a memory device including a plurality of memory blocks each of which includes a plurality of pages that store data;
performing program operations corresponding to the write commands to program data in a first direction in a first memory block group; and
copying the programmed data from the first memory block group into a second memory block group in a second direction.

12. The method of claim 11,
wherein the first direction is a forward direction according to block indices or block numbers of source memory blocks included in the first memory block group, and page indices or page numbers of pages included in each of the source memory blocks, and
wherein the second direction is a reverse direction to the first direction.

13. The method of claim 11, wherein the copying of the data programmed in the first memory block group into the second memory block group in the second direction includes:
detecting map data for source memory blocks included in the first memory block group;
detecting valid pages included in the source memory blocks based on the map data; and
copying the programmed data in the valid pages into target memory blocks of the second memory block group in the second direction.

14. The method of claim 13, wherein the performing of the program operations corresponding to the write commands in the first direction in the first memory block group includes:
programming data into the first memory block group in the first direction from a first source memory block of the first memory block group toward a second source memory block of the first memory block group; and
programming the data into each of the source memory blocks in the first direction from a first page toward a second page.

15. The method of claim 14, wherein the copying of the data programmed in the first memory block group into the second memory block group in the second direction includes:
copying the programmed data in the second direction from the second source memory block toward the first source memory block into the second memory block group; and
copying the programmed data in the second direction from the second page toward the first page of each of the source memory blocks into the second memory block group.

16. The method of claim 15, wherein the copying of the data programmed in the first memory block group into the second memory block group in the second direction further includes:
storing the copied data into the second memory block group in the first direction from a first target memory block toward a second target memory block in the second memory block group; and
storing the copied data into each of target memory blocks in the first direction from a first page toward a second page.

17. The method of claim 11, wherein the copying of the data programmed in the first memory block group into the second memory block group in the second direction further includes:
detecting map data for source memory blocks included in the first memory block group;
copying data stored in all pages of a first source memory block whose map data are not normally detected into the second memory block group; and
copying data stored in valid pages of a second source memory block whose map data are normally detected into the second memory block group.

18. The method of claim 17, further comprising:
detecting valid data for the data copied from the second source memory block through an update of the map data for the second memory block group; and
updating only the valid data when the map data are updated.

19. The method of claim 17, wherein the copying of the data programmed in the first memory block group into the second memory block group in the second direction includes:
copying the programmed data in the second direction from the second source memory block toward the first source memory block into the second memory block group;
copying the programmed data in the first direction from a first page toward a second page in the second source memory block into the second memory block group; and
copying the programmed data in the second direction from a second page toward a first page in the first source memory block into the second memory block group.
wherein the copying of the data programmed in the first memory block group into the second memory block group in the second direction includes:
copying the programmed data in the second direction from the second source memory block toward the first source memory block into the second memory block group; and
copying the programmed data in the second direction from a second page toward a first page in each of the source memory block into the second memory block group.

20. A memory system comprising:
a memory device; and
a controller adapted to control the memory device to perform a garbage collection operation to source memory blocks in reverse of a program order, and to target memory blocks in the program order.
